(19) United States
(12) Patent Application Publication
(10) Pub. No.: US 2004/0185323 A1
(43) Pub. Date: Sep. 23, 2004

(54) Monolithic fuel cell structure and method of manufacture

(76) Inventors: Burt W. Fowler, Mountain City, TX (US); Daniel B. Bullock, The Woodlands, TX (US); Curtis N. Potter, Austin, TX (US)

Correspondence Address: Burt W. Fowler, 206 Live Drive, Mountain City, TX, 78610, US

(21) Appl. No.: 10/767,138

(22) Filed: Jan. 29, 2004

Related U.S. Application Data
(60) Provisional application No. 60/443,901, filed on Jan. 31, 2003.
(60) Provisional application No. 60/443,901, filed on Jan. 31, 2003.

(51) Int. Cl. H01M 8/02; H01M 2/08; H01M 8/24; C25B 9/00

(52) U.S. Cl. 429/38; 429/35; 204/252

(57) ABSTRACT

A fuel cell structure and method of manufacture is disclosed that enables very low cost fabrication using conventional semiconductor manufacturing facilities. The fuel cell structure permits fabrication of all the salient features on a single planar substrate. Current extractor lines, electrodes, catalyst, proton exchange membrane, fuel and oxidizer channels and manifolds, electrical interconnect between cells, and end caps are all fabricated sequentially through additive and subtractive processing on a single substrate. The structure provides for ion exchange membrane conduction to take place perpendicular to the plane of the cell. The design and manufacturing technique allows for the production of a very small elemental cell with high power density. The monolithic structure provides for the stacking of the elemental cells or entire interconnected substrates by virtue of built-in fuel and oxidizer manifold chambers and electrical interconnect fabricated within each elemental cell.

### CROSS REFERENCE TO RELATED APPLICATION

This application claims benefit of U.S. Patent Provisional application Serial No. 60/443,901 filed Jan. 31, 2003. Subject matter set forth in Provisional application serial No. 60/443,901 is hereby incorporated by reference into the present application as if fully set forth herein.

### BACKGROUND OF THE INVENTION

This invention relates to fuel cells and more specifically to fuel cells that can be manufactured using conventional semiconductor fabrication equipment and facilities. The complete fuel cell structure is manufactured sequentially by processing both sides of a single monolithic substrate.

Fuel cells are devices for converting stored chemical energy directly into electricity generally by using conventional fuels such as hydrogen, methane, methanol and gasoline, for example. The oxidizer commonly used is air or oxygen. The liquid fuels are typically reformed, so called, and hydrogen gas is extracted from the fuel then used by the fuel cell. Hydrogen ions are conducted through a cell membrane to a cathode structure while the ionic properties of the membrane prevent the passage of electrons that have been stripped from the hydrogen gas. Electrons are thus forced to flow through an external load and back to the anode to recombine with the hydrogen ions and oxygen to form water. Alternatively hydrogen gas can be used directly with air or oxygen negating the need for a reformer.

The same fuel cell element can be utilized to extract oxygen and hydrogen from water present at the cathode. Applying an external voltage to the cell such that the positive terminal is connected to the cathode in the presence of water causes hydrogen ions to form at the cathode and travel through the cell membrane where they recombine with electrons at the anode to form hydrogen. Oxygen gas is formed at the cathode during the process. The fuel cell can thus be run in reverse as an electrolyzer.

Fuel cells provide a convenient solution for electrical energy production with lower levels of point-of-use pollution, especially small compact fuel cells that can replace batteries for portable electronic components such as cell phones and notebook computers, for example. End of life disposal of fuel cells is expected to be less polluting than that of batteries.

Large stationary fuel cells are in use primarily as backup electrical power where power outages cannot be tolerated. These stationary fuel cells may typically range from 1 KW to in excess of 100 KW. Non-stationary fuel cells have found application to a limited degree in commercial vehicles such as busses where they use natural gas fuel, but the prevalence of such systems is quite limited.

The predominant structure of current fuel cells found in stationary installations is one of component separate parts that are assembled by hand labor. The essential components are a membrane, two electrodes and channeled anode and cathode plates that are assembled together by a variety of means—often simply held in a sandwiched stack by bolting them together. The manufacture and assembly is time consuming and labor intensive. Extending such an approach to manufacturing small portable fuel cells becomes even more difficult and labor-intensive leading to high product cost.

While there is intense current research and development on the materials that go into the manufacture of the core fuel cell focused to improve efficiency and reliability, the manufacturing cost per watt hour is much higher than common current methods of power production such as gasoline generators and batteries, for example.

The fuel cell structure described herein is fabricated on a single flat substrate wherein all the component elements of the fuel cell including membrane, electrodes, catalyst, electrical conductors, and fuel and oxidizer channels are fabricated in a conventional semiconductor fabrication facility. Such fuel cell structure herein described affords the greatest opportunity for manufacturing economy and provides a serious opportunity for the production of fuel cell elements of centimeter square unit cell sizes that can be singulated and stacked or conversely interconnected as an array on a single substrate. Substrate size may be from 4 to 12 inch diameter, for example, for convenient manufacture in a conventional semiconductor fabrication facility. The structure is fabricated with fuel and oxidizer manifold cavities at the edge or through the center of each unit fuel cell, thus allowing unit cells or entire substrates to be stacked together to increase voltage or current output from a stack.

U.S. Pat. No. 4,294,891, to Yao, et al. describes a micro fuel cell that is implantable (in humans) and has a structure that permits refueling through a percutaneous port. Essential components of the fuel cell are fabricated separately then assembled prior to implant.

U.S. Pat. No. 5,641,585, to Lessing, et al. discloses a miniature ceramic fuel cell including an elemental cell with balance of plant. A solid oxide fuel cell is disclosed wherein a planar anode of nickel or zirconium oxide, a planar electrolyte of zirconium oxide, a planar cathode of lanthanum manganese oxide and a planar interconnect of nickel/aluminum are manufactured separately then joined by cobalt/nickel brazing.

U.S. Pat. No. 5,723,228, to Okamoto describes a direct methanol type fuel cell wherein the design discloses a method for uniformly delivering a proper amount of fluid methanol to an entire anode surface. The structure of the elemental fuel cell comprises an ion exchange membrane, anode, cathode, anode gasket, cathode gasket, and two manifold plates fabricated separately then assembled in registration.

U.S. Pat. No. 6,127,058, to Pratt, et al. discloses a fuel cell demonstrating an integrated anode, cathode and membrane on a single substrate and where the anode and cathode is applied to opposite sides of the membrane. Anode and cathode current collector plates are then attached to the opposite sides of the anode, cathode, membrane assembly.

U.S. Pat. No. 6,312,846, to Marsh discloses a miniature fuel cell that is a departure from prior art wherein the active fuel cell components including membrane, electrodes, fuel and oxidizer channels and current conduction paths are built up on a single, channeled, monolithic substrate through sequential depositions of conductive (electrode) and nonconductive (membrane) polymer. Channels are initially formed in the substrate followed by the application of membrane and electrode material and finally a separate gas impermeable cover seals the structure. Also disclosed is an alternative method of manufacture wherein three grooves (membrane, anode and cathode electrode grooves) are etched into the substrate followed by electrical conductor deposition and finally the injection of flowable membrane material into the center groove. The possibility of introducing semiconductor microcontroller devices onto the substrate for the purpose of monitoring various functions of the fuel cell as well as providing sensing and output power control is disclosed.

U.S. Pat. No. 6,387,559 B1, to Koripella, et al. describes a fuel cell system consisting of a fluid supply array of channels in a base structure with a membrane assembly including separate proton conducting membrane, anode and cathode attached to the channeled substrate. The channeled substrate acts as a partial balance of plant for the insertion of fuel and oxidizer to the membrane assembly part of the fuel cell.

U.S. Pat. No. 6,497,975 B2, to Bostaph, et al. discloses a fuel cell assembly as described in U.S. Pat. No. 6,387,559 above but with the addition of an integrated flow field within an upper and lower plate containing fluid and oxidizer flow channels where the stated purpose is to supply a uniform distribution of fuel and oxidizer to a membrane surface.

U.S. Pat. No. 6,541,149 B1, to Maynard, et al. discloses a micro fuel cell wherein fuel and oxidizer channels are formed on two silicon substrates and where a proton exchange membrane is added to one of the substrates then the two substrates are bonded together to form an elemental cell containing membrane, electrodes, catalysts and current collecting members. In another embodiment the elemental cell is formed on a single substrate through sequential buildup of porous membrane, fuel and oxidizer channels, catalyst and electrodes, current carrying conductors and finally a proton exchange membrane. The unique fabrication process provides for ion conduction essentially in the plane of the substrate.

U.S. Pat. No. 6,638,654, to Jankowski, et al. describes a MicroElectroMechanical Systems (MEMS) based fuel cell consisting of three substrates which are bonded together in registration to form a functional micro fuel cell fabricated using principally semiconductor type processing equipment. A porous membrane and electrode/electrolyte layer is provided on a center substrate, which may be silicon or other material, a channeled top substrate with an O2 inlet is provided and finally a bottom substrate with fuel channel and inlet is provided. The three substrates are bonded together to form an elemental fuel cell. Balance of plant equipment is not described.

U.S. Pat. No. 6,641,948 B1, to Ohlsen, et al. discloses a fuel cell structure comprising an anode assembly and cathode assembly fabricated separately from micromachined silicon wafers wherein the anode and cathode components are bonded together using a third bonding structure and the flow channels within the anode and cathode members are sealed using flow channel covers. The fuel cell is unique in that the current extraction means is through the micromachined silicon substrates.

### BRIEF SUMMARY OF THE INVENTION

A fuel cell structure is disclosed wherein a fully functional fuel cell device is formed using both sides of a single substrate. The structure includes a partially removed substrate, anode and cathode current extractors, electrodes, catalyst, Proton Exchange Membrane (PEM), and fully sealed fuel and oxidizer channels feeding to integral or external manifolds.

The fully integrated fuel cell is fabricated on a single substrate by sequential additive and subtractive processes commonly used in semiconductor and MEMS fabrication technology.

The objects and advantages obtained by the fuel cell element derive from the ability to process both sides of a single substrate to form anode and cathode electrodes with fuel and oxidizer channels created by stacking unit cells or arrays of cells together. This enables sequential additive and subtractive processing to complete the invention. Such structure is executed using conventional semiconductor and MEMS microfabrication technology as well as semiconductor packaging technology wherein said technologies are well known in the art.

The structure described results in a hydrogen ion flow perpendicular to the substrate surface while enabling simplification of the fabrication process in that all of the additive and subtractive processes are performed on a single substrate rather than having to fabricate and assemble more than one component in order to form the unit cell.

The approach enables the use of insulator materials to be deposited by conventional techniques such as sputtering, evaporation, and chemical vapor deposition, for example. The use of insulator materials is important for the prevention of corrosion and electrical isolation, for example.

The planarity of the cell structure is important in minimizing the amount of catalyst used during fabrication. The application of catalyst can be implemented by means of vacuum deposition, plating or chemical vapor deposition and is thus restricted to the vicinity of the membrane/electrode interface rather than dispersed throughout the entire electrode structure.

The sequential thin and thick film technology used in fabrication of the fuel cell element along with the design provides a basic structure that takes advantage of fuel cell material improvements that are evolutionary in nature.

The structure design and fabrication process for the fuel cell allows the incorporation of refractory barrier materials within fuel and oxidizer channels as well as anti corrosion layers that can be applied to current extractor lines.

Specifically the entire fuel cell structure is fabricated using conventional semiconductor technology with its' attendant high-resolution lithography and high yield for mature processes. Such fabrication capability allows a very wide window of dimensional control in the thickness of the membrane (from a few to several hundred micrometers). Robust, low resistance, plated, current carrying electrodes are enabled using simple plating technology. Uniquely the entire fuel cell structure is fabricated sequentially on a single substrate.

The method of manufacture allows portions of the substrate to remain in the final structure in order to provide mechanical support for the membrane and to form fuel and oxidizer channels that can be connected to the fuel and oxidizer source in multiple ways.

Specifically, the fuel and oxidizer channels can be configured such that they enter and exit from the sides of the fuel cell through external manifolds so that the fuel and oxidizer flow parallel to the surface of each cell. Alternatively, the fuel and oxidizer manifolds can be configured as integral parts of each cell so that the fuel and oxidizer flow perpendicular to and spread laterally across the surface of each cell. In the case of perpendicular fuel and oxidizer flow, an external manifold is not required and the fuel and oxidizer can be introduced and exhausted from the top or bottom of the stack via tubulation connected to the external balance of plant. Finally, the fuel and oxidizer channels can be configured so that a combination of parallel and perpendicular flow is achieved.

### BRIEF DESCRIPTION OF THE DRAWINGS

FIG. 1a illustrates prior art wherein component members are fabricated separately then assembled together in FIG. 1b

FIG. 2 details an oblique, cutaway view of the salient features and structure of a present embodiment of the invention.

FIG. 3a through 3e illustrates a preferred embodiment of a fabrication sequence from starting substrate through the first patterning sequence of interconnect layer 1.

FIG. 4a through 4e illustrate a continuation of a preferred embodiment of the interconnect layer 1 fabrication sequence from nitride deposition through formation of trenches for the first metal interconnect lines.

FIG. 5a through 5d indicates a continuation of a preferred embodiment of the interconnect layer 1 fabrication sequence from current extractor barrier layer deposition through isolation of the first metal interconnect lines and deposition of dielectric at the membrane level.

FIG. 6a through 6c delineates a continuation of the preferred embodiment of the membrane electrode assembly through patterning of the first membrane layer insulator.

FIG. 7a through 7c illustrates a continuation of the preferred embodiment of the membrane electrode fabrication process from the deposition of the second membrane insulator material through planarization and masking of the first membrane level insulator material.

FIG. 8a through 8c illustrates a continuation of the preferred embodiment of the membrane electrode assembly fabrication process from the second etch of the first membrane level insulator through application of a third resist mask to the first membrane level insulator.

FIG. 9a through 9d illustrates a continuation of the preferred embodiment from etch of the first membrane level insulator down to the first metal interconnect through deposition of the first porous electrode.

FIG. 10a through 10c illustrates in a preferred embodiment a continuation of the membrane assembly from porous electrode patterning through resist strip.

FIG. 11a through 11c illustrates in a preferred embodiment a continuation of the fabrication process from membrane deposition through membrane masking.

FIG. 12a and 12b illustrate in a preferred embodiment a continuation of the fabrication process from etching of the membrane through resist strip. FIG. 12c shows a schematic view of an ideal membrane assembly with maximized surface area. FIG. 12d illustrates in a preferred embodiment the deposition of the second porous electrode layer.

FIG. 13a through 13c illustrates in a preferred embodiment a continuation of the membrane electrode assembly fabrication process from pattern of porous electrode 2 through resist strip.

FIG. 14a through 14c illustrates in a preferred embodiment a continuation of the fabrication process from deposition of the first interconnect layer 2 insulator through patterning and etch.

FIG. 15a through 15c illustrates in a preferred embodiment a continuation of the interconnect layer 2 fabrication process from resist strip through planarization of the first and second insulators of interconnect layer 2.

FIG. 16a through 16c illustrates in a preferred embodiment a continuation of the fabrication process from resist patterning of the planarized surface through formation of trenches at interconnect layer 2.

FIG. 17a through 17c illustrates in a preferred embodiment a continuation of the fabrication process from interconnect layer 2 barrier metal deposition through isolation of the metal lines in interconnect layer 2.

FIG. 18a through 18c illustrates in a preferred embodiment a continuation of the fabrication process from passivation of interconnect layer 2 through etch of the passivation layer.

FIG. 19a through 19c illustrates in a preferred embodiment a continuation of the fabrication process from capping of interconnect layer 2 metal lines through resist patterning for channel etch.

FIG. 20a through 20b illustrates in a preferred embodiment a continuation of the fabrication process from etch of the flow channels through resist strip.

FIG. 21a through 21c illustrates in a preferred embodiment a continuation of the fabrication process from patterning and etch of the substrate backside layer through resist strip.

FIG. 22a through 22b illustrates in a preferred embodiment a continuation of the fabrication process from substrate etch through removal of insulator from between metal lines in interconnect layers 1 and 2.

FIG. 23a and 23b illustrate in a preferred embodiment the stacking and sealing of singulated cells.

FIG. 24a and 24b illustrate in a preferred embodiment how the substrate can be patterned to create flow channels across the cell interior.

FIG. 25a and 25b illustrate in a preferred embodiment how the passivation layer can be patterned to create flow channels across the cell interior.

FIG. 26a illustrates in a preferred embodiment how flow can enter vertically and be channeled horizontally across stacked cells and exhausted from the cell edge. FIG. 26b illustrates in a preferred embodiment how flow can enter vertically and be channeled horizontally across stacked cells and exhausted vertically from the stacked cells. FIG. 26b also illustrates how unpatterned cells within the monolithic substrate can be used as top and bottom caps.

FIG. 27a through 27c illustrates the simplest embodiment of the present invention using a planar membrane electrode assembly and seals around the cell edges.

FIG. 28a through 28d illustrates in a preferred embodiment the fabrication process for vertical interconnect through exposing the substrate at the vertical interconnect regions.

FIG. 29a through 29d illustrates in a preferred embodiment a continuation of the vertical interconnect fabrication process from silicide metal deposition through formation of the trenches in interconnect layer 2.

FIG. 30a through 30c illustrates in a preferred embodiment a continuation of the vertical interconnect fabrication process from patterning and etch of the vertical interconnect through resist strip.

FIG. 31a through 31c illustrates in a preferred embodiment a continuation of the vertical interconnect fabrication process from interconnect layer 2 barrier metal deposition through planarization of interconnect layer 2.

FIG. 32a through 32c illustrates in a preferred embodiment a continuation of the vertical interconnect fabrication process from passivation layer deposition through pattern and etch.

FIG. 33a through 33c illustrates in a preferred embodiment a continuation of the vertical interconnect fabrication process from deposition of contact metal through patterning of the passivation layer to expose passivation regions between the interior metal lines of interconnect layer 2.

FIG. 34a through 34c illustrates in a preferred embodiment a continuation of the vertical interconnect fabrication process from etch of passivation layer through the final vertical interconnect structure.

FIG. 35a and 35b illustrate in a preferred embodiment the vertical interconnect arrangement for parallel connections between stacked cells.

FIG. 36a and 36b illustrate in a preferred embodiment the vertical interconnect arrangement for series connections between stacked cells.

FIG. 37 details an oblique, cutaway view of the salient features and structure of a preferred embodiment of the invention.

FIG. 38a through 38c shows stacked fuel cells with several different options for fuel and oxidizer flow and electrical connection.

### DETAILED DESCRIPTION OF THE INVENTION

A micro fuel cell structure and process is disclosed that enables a low cost of manufacturing benefit. Although the following detailed description delineates many specific attributes of the invention and describes specific fabrication procedures, those skilled in the art of microfabrication will realize that many variations and alterations in the fabrication details are possible without departing from the generality of the preferred embodiment of the structure as described.

The most general attributes of the invention relate to a fuel cell structure that is fabricated wholly on a single substrate wherein all of the salient cell components are sequentially built up using conventional semiconductor or MEMS processing techniques. Ion conduction takes place perpendicular to the substrate. The invention provides for a reduced manufacturing cost benefit derived from the ability to fabricate the entire structure through sequential processing in a semiconductor or MEMS type fabrication facility. The basic cells are stacked to provide fuel and oxidizer access to the membrane. Manifold channels are opened by masking and etching from the back and front sides of the monolithic substrate. Arrays of fully functional micro fuel cells are fabricated on a single substrate then, if desired, singulated for use in stacked arrays.

Fuel and oxidizer manifolds are partially fabricated within the unit fuel cells so that, as cells are stacked, channels are automatically connected out the sides or up through the stack and are available for connection to an external source of fuel and oxidizer from balance of plant hardware via an attached tubulation or manifold. The completed micro fuel cells can be stacked by soldering, bonding or other means known in sealing art to achieve higher output current or voltage.

Optionally, entire substrates of interconnected individual fuel cell elements may be stacked to provide a high power fuel cell module. At current state of the art, power densities of 0.5 watt per square centimeter over an 8-inch diameter substrate containing 150 interconnected cells of 0.5 watts each yields 75 watts. A module of 15 stacked substrates yields 1 KW in a stack volume of 150 cubic centimeters.

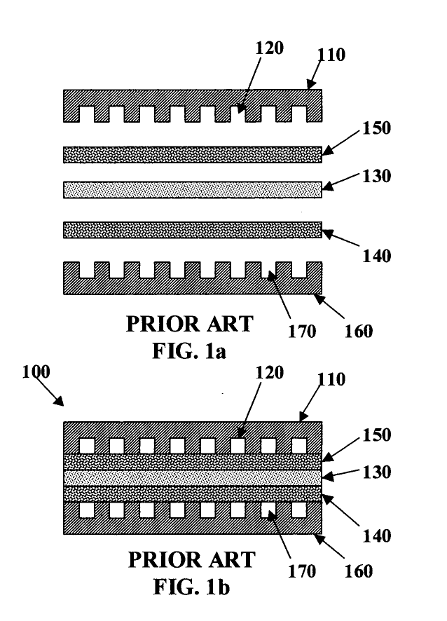

The technology in prior fuel cell art has focused on building both macro and micro cells as component parts. To form a functional fuel cell element the component parts are assembled together in a stack generally with some sort of component feature registration required. FIG. 1a shows in simplified form a fuel cell element 100 consisting of five component parts (balance of plant not included). 110 and 160 are current carrying members fabricated separately while 140 and 150 are electrode members also generally fabricated separately. Membrane 130 is also fabricated separately. These pieces are then bonded together as in FIG. 1b to form a functional fuel cell element. The assembly process can be expensive and time consuming and does not lend itself to a continuous manufacturing process. Recent interest in micro fuel cell technology for portable electronic applications has resulted in fuel cell designs that are amenable to conventional microfabrication manufacturing techniques. Much of this work has focused on building parts of the fuel cell element separately using conventional microfabrication technology but then assembling the component parts to obtain a fully functional cell. This patent discloses a structure wherein all component parts are integrated within and fabricated sequentially on a single substrate.

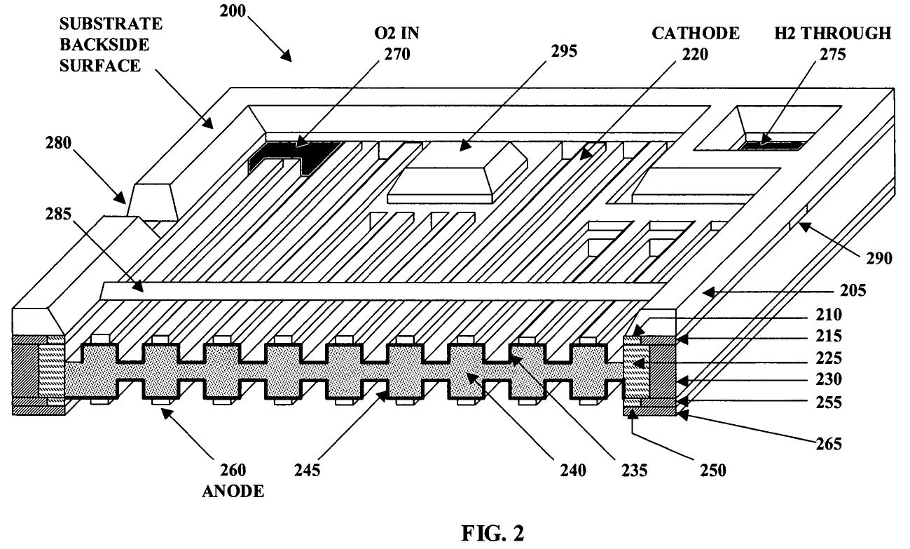

FIG. 2 delineates a cut away view of a preferred embodiment of the disclosed completed monolithic fuel cell element 200 showing, for simplicity, only the principal components. The fuel cell is built up sequentially using conventional microfabrication techniques on substrate 205. Design of the structure permits fabrication to be executed in a conventional semiconductor fabrication facility that employs thin film deposition equipment, wet and dry etching equipment, plating equipment, lithography equipment, polishing equipment and electrical probing equipment.

The fuel cell of FIG. 2 represents a greatly simplified embodiment of an actual cell and the structure represented will be recognized as a functional fuel cell element by those skilled in the art. Some details, such as a layer that insulates the metal conductors from the substrate and protects them from fuel and oxidizer, are not shown in FIG. 2 but will be described in detail in later figures.

The fuel cell is fabricated on substrate 205 which can be semiconducting, insulating or metal. The starting substrate is planar and unpatterned in order to be compatible with conventional processing equipment. A first insulator layer 210 is deposited on both sides of the substrate. For a Si substrate this layer could be grown using thermal oxidation for example. The substrate frontside is masked and etched down to the substrate to form trenches around the cell perimeter. Insulator layer 215 is then deposited. Of many possible techniques to remove layer 215 where it overlays layer 210, Chemical Mechanical Planarization (CMP), for example, can be used to planarized the surface and expose layer 210 while layer 215 is left exposed in the trenches around the cell perimeter.

The interior of the cell is then patterned with trenches and layer 210 is etched down to the substrate. Metal layer 220 is then deposited and CMP is used to form metal lines that act as the cathode current collector. The metalization process can include first depositing an insulating layer, not shown in FIG. 2, at the substrate interface to attach the metal lines to the substrate and insulate the lines from the substrate.

Insulating layer 225 is then deposited, masked and etched down to layer 215. Insulating layer 230 is deposited and layers 230 and 225 are planarized using CMP to leave layer 230 only around the perimeter and in regions where access holes 270 and 275 will later be created. Layer 225 is then patterned and etched twice in the cell interior to form trenches down to metal conductors 220.

A conformal layer 235 of porous electrode material is then deposited. Layer 235 can contain a catalyst such as Pt or Pt/Ru, or the catalyst can be applied after layer 235 is deposited. Layer 235 is masked and etched to remove it from around the cell perimeter.

Next, a continuous layer 240 of proton exchange membrane is applied and heat-cured as necessary. Such a proton exchange membrane can be applied by spin-coating a Nafion solution, for example, or by doctor-blading a similar solution across the surface. Layers 225, 230 and 240 can then be planarized using CMP to remove layer 240 from the cell perimeter. Layer 240 is then masked and trenches are etched partially into the membrane material. Pt or Pt/Ru catalyst and a second porous electrode layer 245 are then deposited, masked and etched to remove layer 245 and catalyst from the cell perimeter.

Insulating layer 250 is deposited, masked, and etched to form trenches extending down to layer 230 around the cell perimeter. Insulating layer 255 is deposited and CMP is used to planarized the surface and leave layer 255 only in the trenches around the cell perimeter. Layer 250 is then patterned in the interior of the cell and etched to form trenches down to layer 245. Metal layer 260 is then deposited and planarized using CMP to form the anode current collector. Insulating layer 265 is then deposited, planarized if necessary, masked, and etched so that it only remains around the cell perimeter and over holes 270 and 275. Oxidizer access hole 270 and fuel channel 275 can then be partially created by masking and etching layers 265, 250, 225, and 210 down to the substrate 205.

The substrate backside is then masked, patterned and layer 210, which still fully coats the substrate backside, is etched down to the substrate for use as a hard mask for a subsequent substrate etch. It may be noted that this is only one possible technique to accomplish substrate removal, and that the general structure shown in FIG. 2 can be fabricated using any number of techniques as will be recognized by those skilled in the art of microfabrication.

The exposed portions of layers 210 and 225 are then removed from in between metal conductors 220 using a wet etch, for example. At the same time, exposed portions of layer 250 are etched from the frontside and removed between metal lines 260. Layers 215, 230, 255 and 265 are designed to be resistant to the wet etch so that they remain in the structure at the cell perimeter.

FIG. 2 also shows a gap 280 in the substrate that can be created during etch of substrate 205. Such a gap can be placed anywhere around the perimeter to enable many potential oxidizer and fuel inlet and exhaust configurations. For example, the oxidizer can enter through hole 270 in FIG. 2 while water created within the cell and unused oxidizer can exit through gap 280.

Support beam 285 in FIG. 2 is also formed during the substrate etch if needed to increase the mechanical strength of the cell. For example, for silicon substrate the substrate etch can be an anisotropic crystallographic etch such as KOH and water to fabricate beams both along, and orthogonal to, the direction of beam 285 in FIG. 2. Patterning narrow masks on the substrate backside and properly timing the etch will leave thin beams of substrate material still attached to the substrate around the cell perimeter and the tops of cathode metal conductors 220. By properly choosing the dimensions of beam 285, layer 210 underneath the beam can be removed during processing so that no loss of active membrane area is incurred by including these structures. Therefore, these structures can be used in any suitable arrangement as needed to increase mechanical strength without blocking oxidizer or fuel flow to the membrane.

Cells, or arrays of cells, can then be singulated, stacked and sealed such that the original substrate backside surface is sealed to layer 265 around the cell perimeter and around fuel channel 275.

The singulation procedure exposes the metal cathode conductor 290 in FIG. 2 routed to the cell perimeter so that connection to other cells or external circuitry can be made. Alternatively, current can exit the cell through vertical interconnect 295 formed from a conductive substrate.

Not shown in FIG. 2 is a layer that insulates cathode conductor lines from the substrate, attaches lines to beam 285, and protects lines from chemical reaction with oxidizer and oxidation byproducts. Although this layer may not be required for fuel cell operation, because of its potential benefits it is included in the fabrication process detailed below with no loss of generality.

With current microfabrication capability, many unit cells can be built onto a single substrate, singulated by standard semiconductor sawing or laser scribing technology, for example, stacked and interconnected to form the fuel cell. For a stack design containing N cells, two out of every N+2 cells across the substrate can be used as the top and bottom of the stack to eliminate the need to fabricate the top and bottom pieces separately. These two cells can be patterned and etched to provide access for fuel and oxidizer inlets and exhausts and electrical connection as needed depending on the specific fuel cell configuration.

The aforementioned fuel cell is a completely functional fuel cell (minus balance of plant) fabricated by sequential processing on a single substrate. Connection to balance of plant is accomplished through attachment of tubulations, manifolds, or conductors to regions 275, 280, 290 and 295 shown in FIG. 2 by various means such as o-ring pressure seal, epoxy seal, brazing or soldering, for example.

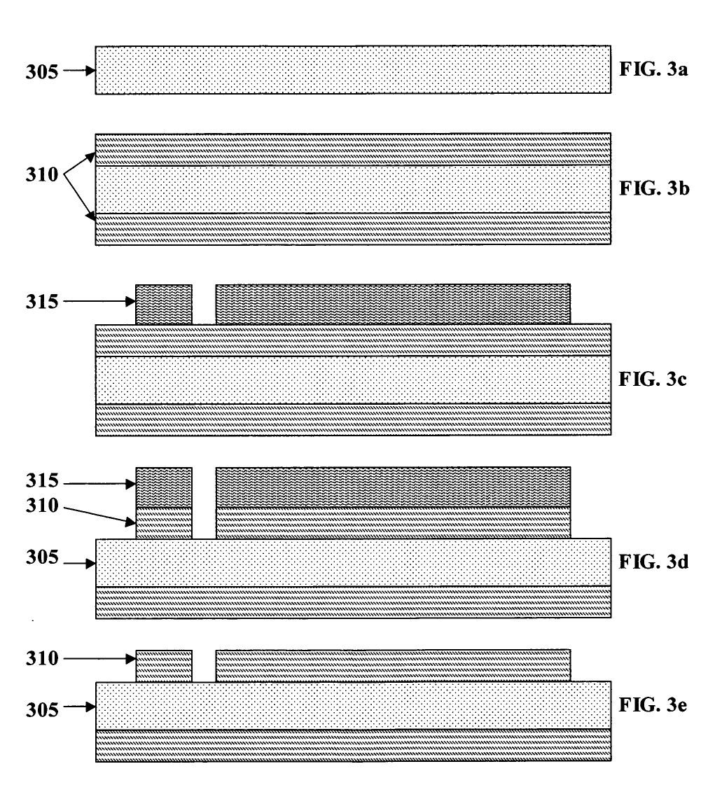

While a simplified sectional view of the disclosed fuel cell element is shown in FIG. 2. A more detailed description is disclosed for a preferred embodiment in FIG. 3 through FIG. 22. These figures show a cross-section of a single unit cell and demonstrate how anode and cathode conductors are placed next to the proton exchange membrane, how they are routed to the cell perimeter, and how through holes are fabricated. The specific processes presented are typical of a modern microfabrication facility and include so-called damascene processes where films are deposited and etched to form trenches that are then filled with another material and the entire surface planarized using a polishing technique. Accordingly, the specific process flow described is only one example of a variety of materials and fabrication techniques that are well known in microfabrication art.

Referring to FIG. 3a, a starting substrate may be metal, semiconductor or insulator. Copper, silicon and glass are examples of possible substrate materials. If substrate 305 is silicon a first insulator layer 310 in FIG. 3b of silicon dioxide, for example, can be grown over the front and back silicon surface by thermal oxidation. Layer 310 will support fabrication of metal interconnect 1. Resist mask 315 in FIG. 3c is patterned by conventional lithographic means to expose the cell perimeter and regions around through holes, and layer 310 is etched down to substrate 305 in FIG. 3d using Reactive Ion Etch (RIE), for example, or a suitable wet etch. The resist is then stripped as shown in FIG. 3e.

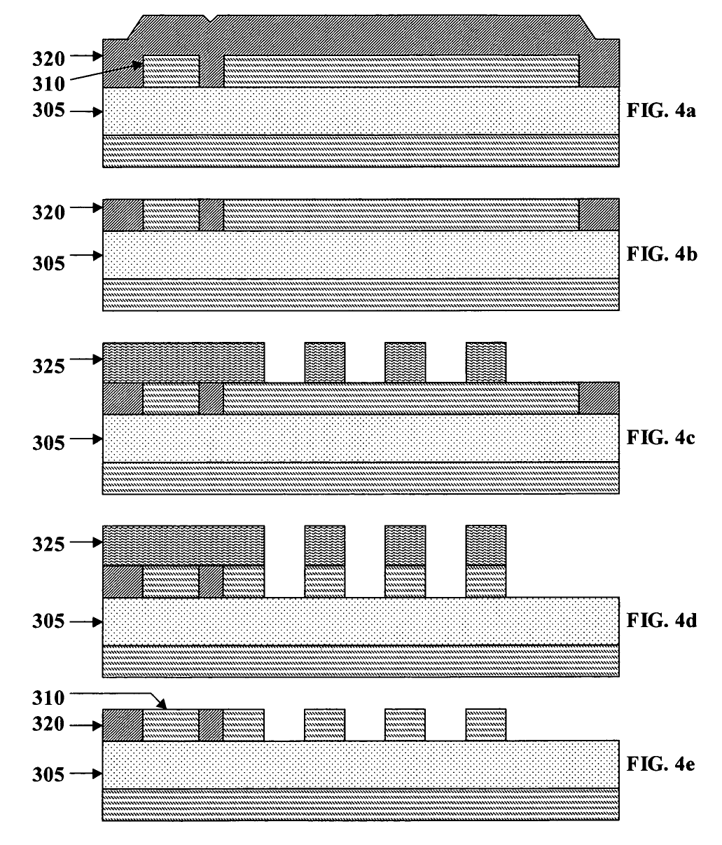

Referring to FIG. 4a, insulator layer 320 is deposited with a thickness sufficient to fill the trenches. Silicon nitride can be used as the insulator, for example, and can be applied by Physical Vapor Deposition (PVD) or by Chemical Vapor Deposition (CVD), for example. High-density plasma CVD is typically used in the microfabrication art to completely fill high aspect ratio trenches with width as small as 0.1 micron. Planarization using CMP leaves layer 320 only in the trenches around the cell perimeter and where through holes will be located as shown in FIG. 4b. Resist mask 325 in FIG. 4c is fabricated on top of layers 310 and 320. In FIG. 4d, an RIE etch through layers 310 and 320 down to the substrate forms the trenches that will become metal conductors. The resist is stripped in FIG. 4e.

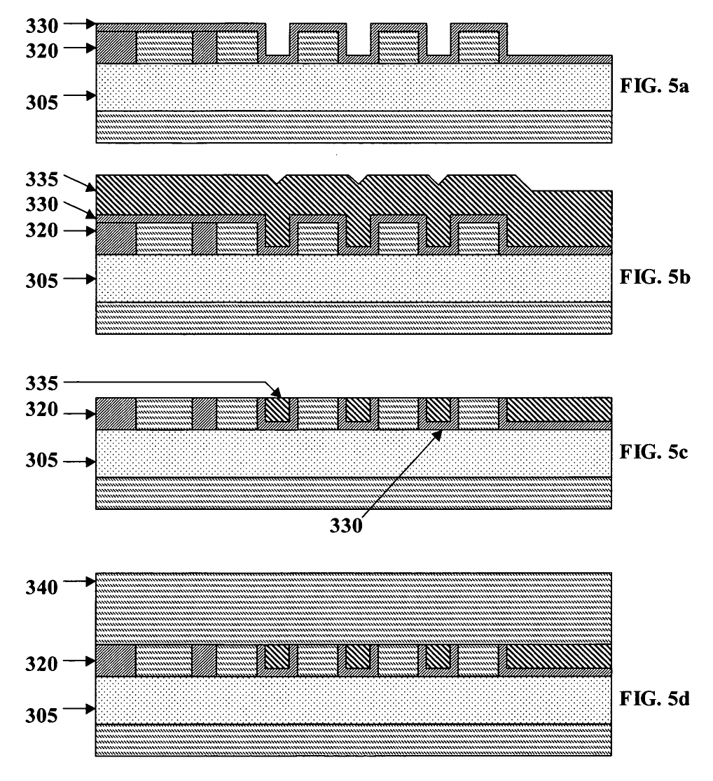

Fabrication of metal interconnect 1 continues as shown in FIG. 5a. A thin conformal layer 330 is deposited using CVD, for example. Layer 330 is used if needed to insulate metal interconnect from the substrate, attach metal lines to the substrate, and protect metal lines from chemical attack by fuel, oxidizer, and fuel cell byproducts. Using silicon nitride for example for layer 330 also provides a copper diffusion barrier so that copper will not migrate into surrounding materials.

Metalization of interconnect 1 is next, and can be accomplished for example using standard copper processing techniques where a first layer of Ta or TaN barrier metal is typically deposited to a thickness on the order of 0.05 micron using PVD followed by plated copper seed and fill layers. FIG. 5b shows the cell after the copper fill layer 335 is plated. As shown in FIG. 5c, subsequent CMP planarizes the surface by polishing through layer 335, the plated copper seed (not shown), the barrier metal (not shown), and layer 330 to form metal interconnect 1. Thickness of interconnect lines meet the requirement for minimum voltage drop for extracted current and may be additionally used to conduct heat away from the proton exchange membrane.

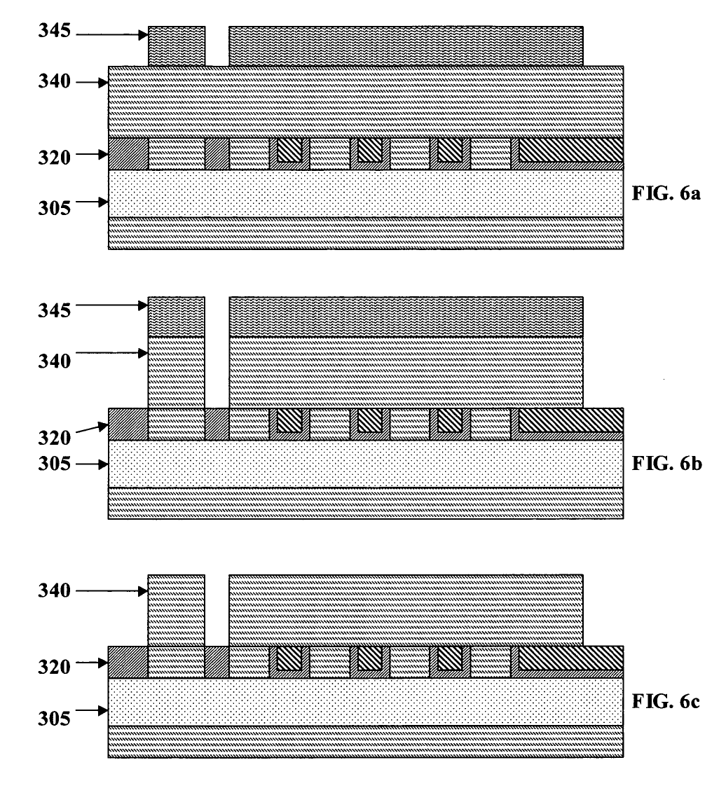

Membrane electrode assembly now begins by using PVD or CVD to deposit for example silicon dioxide layer 340 in FIG. 5d. Resist mask 345 in FIG. 6a is applied to layer 340 for etch down to layer 320 in FIG. 6b. The resist mask is then stripped in FIG. 6c.

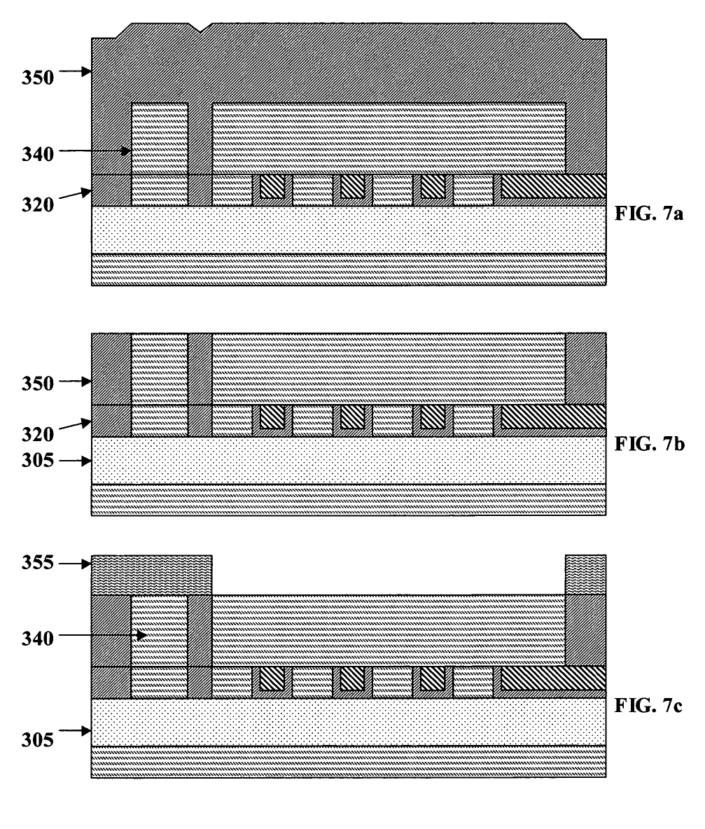

In FIG. 7a, silicon nitride layer 350 is deposited to fill the trenches around the cell perimeter and through-hole regions followed by CMP to planarize the surface in FIG. 7b. Resist mask 355 in FIG. 7c exposes layer 340 in the interior of the cell.

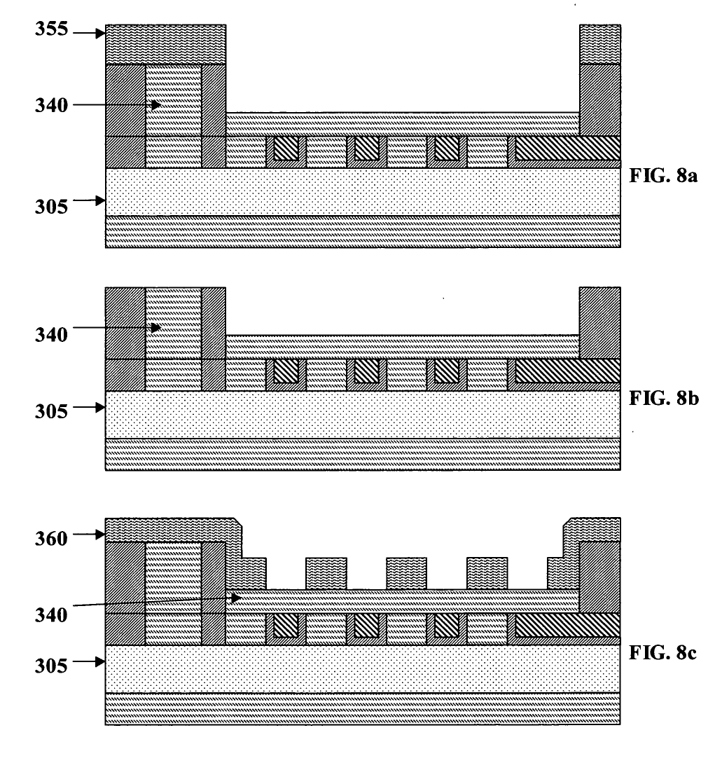

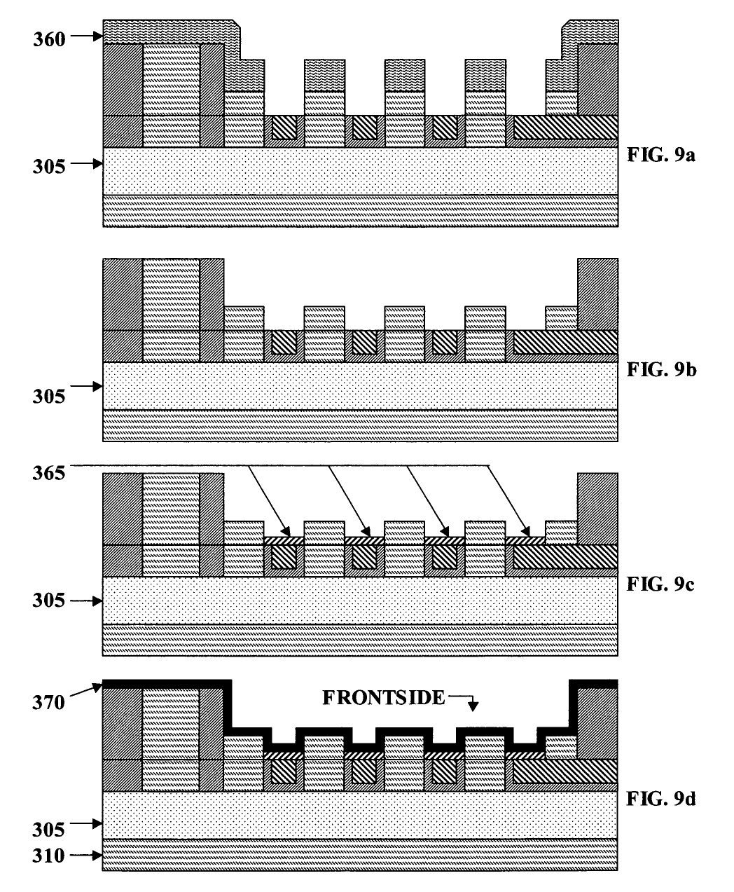

In FIG. 8a, layer 340 has been etched approximately two-thirds the way through. The resist is stripped in FIG. 8b, and resist mask 360 is applied in FIG. 8c. The remaining one-third of exposed layer 340 is etched using RIE for example down to the metal conductors in FIG. 9a and the resist is stripped in FIG. 9b. The exposed copper can be capped with a metal film if needed to protect against corrosion by chemicals present in the porous electrode and proton exchange membrane. Plating can be used to form metal cap 365 in FIG. 9c. The cap can be any platable material, such as nickel, for example, but may be more specifically determined by the nature of the corrosion expected between the conductor and proton exchange membrane material for the fuel and oxidizer used.

Porous electrode layer 370 is then deposited as in FIG. 9d. The porous electrodes typically used in a Polymer Electrolyte Membrane Fuel Cell (PEMFC) are carbon-based and electrically conductive. Similar porous carbon-based materials can be deposited using CVD or PVD for example to provide a conformal film, or can be spun-on or doctor-bladed and cured. This layer can contain a catalyst such as Pt/Ru as is typical for a PEMFC, or the catalyst could for example be applied after layer 370 by a PVD or CVD technique. Alternatively, catalyst loading of porous electrode 370 could occur after patterning, as described in detail below.

For the case of a Solid Oxide Fuel Cell (SOFC), common materials include yttria-stabilized zirconia and lanthanum strontium manganite. These materials could be deposited using PVD from a solid target designed to have the proper stoichiometry. The structure described herein can thus be used in a range of fuel cell technologies and new fuel cell materials can be incorporated as they are developed.

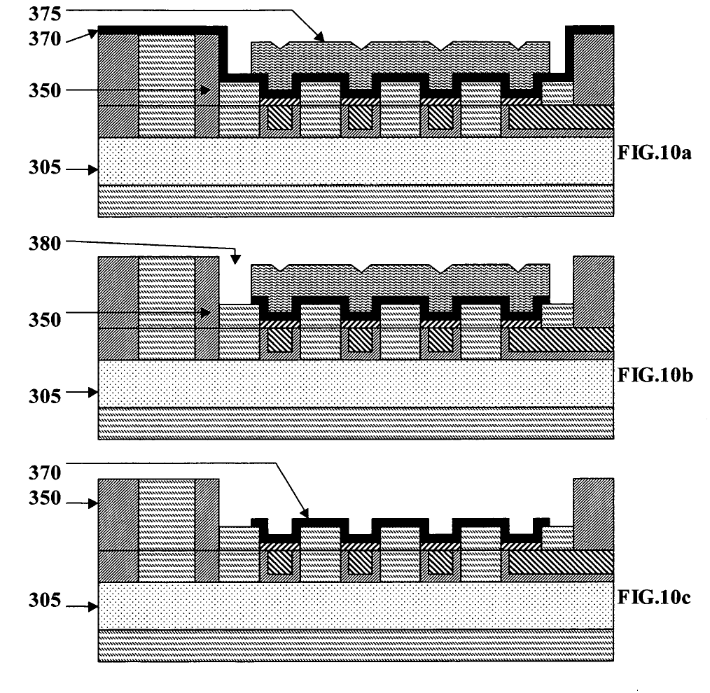

Continuing now with the membrane electrode assembly, resist mask 375 in FIG. 10a exposes porous electrode 370 at the perimeter and around through holes. The porous electrode, being a carbon-based material typical for a PEMFC, can be etched for example with isotropic oxygen plasma to remove it from exposed planar regions as well as the sidewall of layer 350 in FIG. 10b. Since common resist masks are also etched in oxygen plasma, layer 375 can be made much thicker than the thin porous electrode layer and the gap 380 between the layer 350 sidewall and the first metal conductor can be designed to allow for resist mask pullback. Alternatively, a thin dielectric hardmask could be deposited, the resist mask applied, and the hardmask etched to expose porous electrode layer 370. In this case, the hardmask protects the porous electrode from oxygen plasma and a thin resist can be used and completely consumed during the oxygen plasma etch. Regardless of the approach, if porous electrode 370 is already loaded with catalyst, a brief wet etch for example with diluted HNO3/HCI will remove noble metals such as Pt so that any residual catalyst not removed by the oxygen plasma etch is removed before stripping the mask to leave porous electrode and catalyst only over the active region as in FIG. 10c.

Advantages of loading the porous electrode with catalyst at the process point of FIG. 10c include the ability to selectively load catalyst into the porous electrode and reduced chance of surface contamination during mask and etch of layer 370. Prior to catalyst application the surface of layer 370 in FIG. 10c may be treated to increase surface roughness. A brief ion mill using for example argon or a chemical etch such as HF/H2O2 or HNO3 would, depending on the materials chosen for the porous electrode, roughen the surface to increase available sites for Pt catalyst and thus provide enhanced areas for hydrogen ionization near the membrane. Applying a chemical etch including HF, which may be used in solution with H2O2 to roughen carbon- and silicon carbide-based materials, would also thin any exposed silicon dioxide. Reflux in HNO3/H2SO4 creates acidic sites on carbon materials such as carbon nanotubes for example that have high affinity for noble metals. Furthermore, HNO3 and H2SO4 do not aggressively etch silicon dioxide or silicon nitride.

Platinum catalyst can be deposited for example using hexachloroplatinic acid solved in alcohol followed by heat treatment. Pt particles of diameter on the order of 10 nanometers readily bond to acidic sites created by prior HNO3/H2SO4 treatment. Other deposition techniques for Pt and Ru catalysts include but are not limited to physical and chemical vapor deposition processes with thickness control less than 100 angstroms, arc discharge to create nanoparticles of diameter on the order of 1 nanometer, and other methods well known in the microfabrication art.

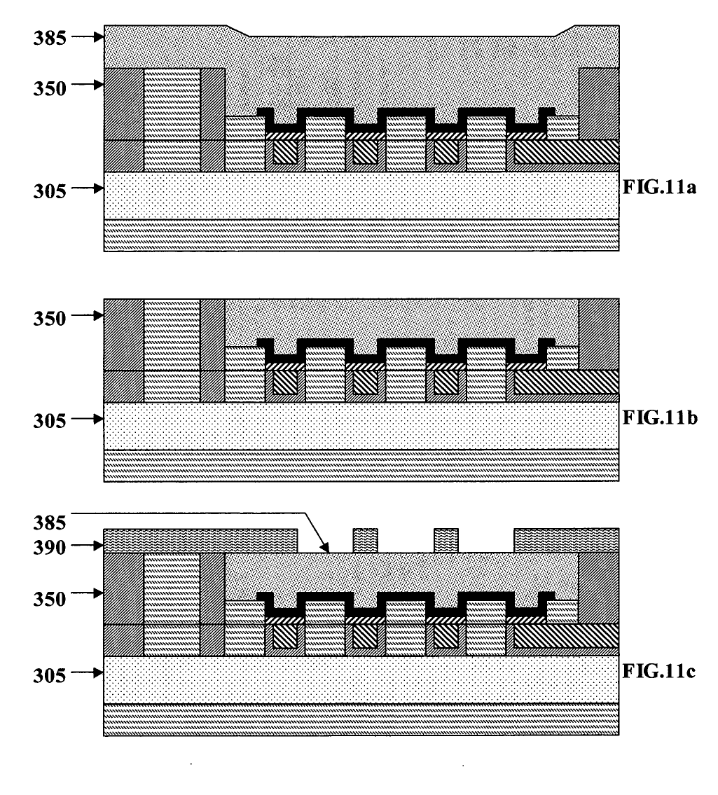

The membrane electrode assembly continues in FIG. 11a, where a solvent-based resin suspension similar to what is used in modern integrated circuits to form low-density, low dielectric-constant insulators is spun-on or doctor-bladed over the surface and heat-cured to solidify. In conventional fuel cell membrane electrode assembly, Nafion solutions for example are commonly sprayed onto solidified Nafion proton exchange membranes to promote adhesion to paper-like, carbon-based porous electrodes. Applying the solution onto a roughened area will allow the membrane to penetrate into electrode regions high in catalyst concentration thereby increasing sites for hydrogen ionization. Using heat- or air-curing, the Nafion suspension or a similar solution will solidify and form proton exchange membrane 385 in FIG. 11a.

The ability to form a highly planarized film using standard spin-on or doctor-blading techniques aids in the removal of layer 385 from around the cell perimeter in FIG. 11b. CMP techniques to polish low-density, polymeric, dielectric materials are readily available, and should be capable of planarizing similar, Nafion-like polymeric films. Alternatively, because of its high degree of planarity, layer 385 can be blanket etched using RIE, for example. In this case, the top of layer 385 may be slightly below the top of layer 350 in FIG. 11b.

The ability to deposit membrane material using a standard spin-on process also allows for extremely tight control over membrane thickness. More importantly the membrane can be made very thin which will reduce the internal resistance of the fuel cell resulting in a flatter response for the cell voltage versus current per unit area polarization curve and an associated increase in maximum power density.

The disclosed structure is compatible with advances in fuel cell materials and designs and can be used for fuel cells other than those based on a polymer proton exchange membrane. Yttria-stabilized zirconia ceramic materials could be deposited for example using PVD as an electrolyte for use in a SOFC.

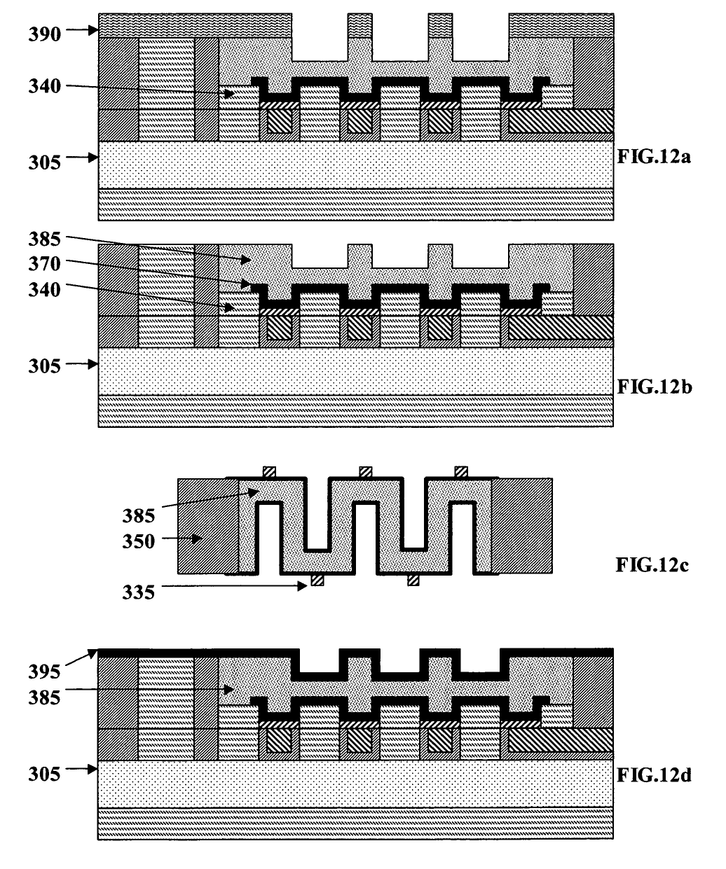

Continuing now with the membrane electrode assembly, FIG. 11c shows resist mask 390 with trenches patterned over membrane 385. The membrane is etched partially through in FIG. 12a to increase active surface area. Resist is stripped in FIG. 12b. Potential issues associated with depositing and removing resist on the membrane material may be addressed by using a hardmask.

Patterning deep trenches or holes in the membrane can greatly increase current density by increasing membrane surface area. This ideal structure is shown schematically in FIG. 12c where only a completed membrane electrode assembly with upper and lower interconnect are shown. Combined with small interconnect metal width, this will maximize active surface area. The trenches on the bottom side of membrane 385 are formed prior to membrane deposition by etching into layer 340. Current deep RIE processes can easily achieve a ten to one aspect ratio in dielectric materials. Etching trenches with similar aspect ratios into membrane 385 would result in an increase in surface area, and correspondingly current density, by a factor of approximately six. For more modest aspect ratios of three to one similar to that depicted in FIG. 12c, the active area is increased by a factor of approximately 2.5. Depositing the membrane and porous electrodes as conformal films on high aspect ratio trenches or holes would allow additional, very tight control of membrane thickness.

Since the electrical resistance of the metal current collectors is small compared to that of the porous electrode material, the current collector width can be made small as compared to the width of the trenches. Current microfabrication technology is capable of metal line widths on the order of 0.1 micron. At this scale, a significant amount of fuel or oxidizer can flow under the metal line through the porous electrode and contribute to the energy-making process, thus making the active area insensitive to the width of the metal line.

Continuing now with fabrication of the membrane electrode assembly, prior to depositing the next porous electrode, which can be the same material as layer 370, a surface roughening step such as ion milling or acid treatment may be applied to membrane 385 in FIG. 12b. Catalyst deposition can be performed as previously described using PVD, CVD and arc-discharge, or, alternatively, porous electrode 395 in FIG. 12d can include a catalyst.

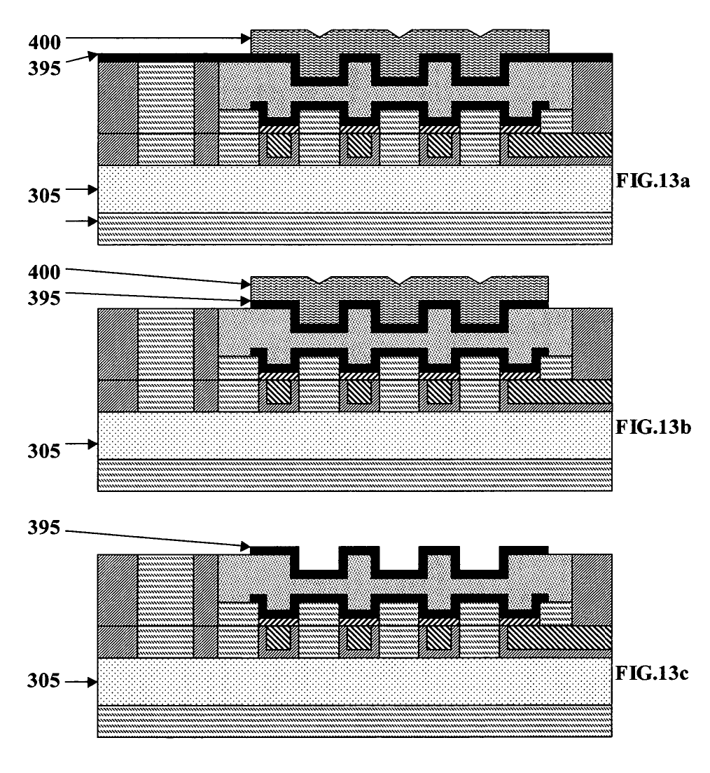

Resist mask 400 in FIG. 13a is used to remove porous electrode 395 from the cell perimeter in FIG. 13b followed for example by a diluted HNO3/HCI wet etch to remove any residual catalyst and a resist strip in FIG. 13c. This completes membrane electrode assembly.

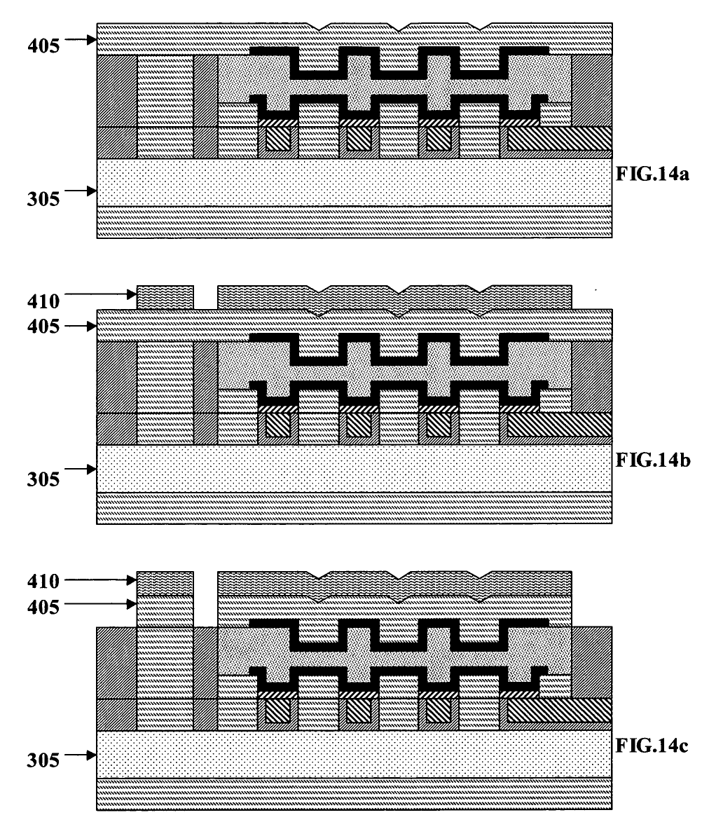

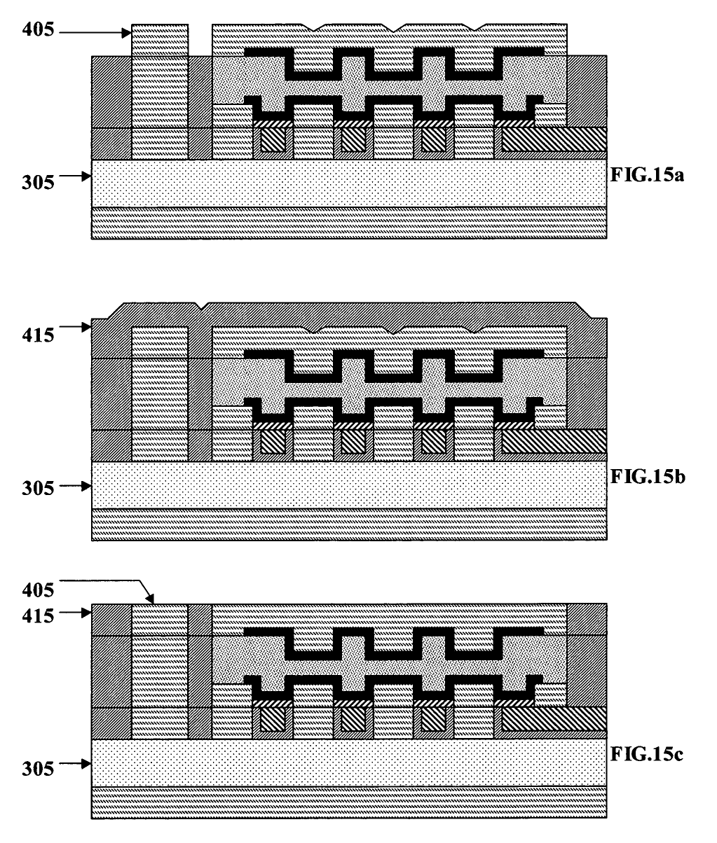

The first step in forming metal interconnect 2 is shown in FIG. 14a. Layer 405 is for example a silicon dioxide film deposited by CVD. Resist mask 410 in FIG. 14b is used to remove layer 405 from the cell and through-hole perimeters. Layer 405 removal in FIG. 14c can be accomplished for example using RIE. The resist mask is stripped in FIG. 15a. An insulating layer 415, for example silicon nitride, is deposited in FIG. 15b and planarized using CMP in FIG. 15c.

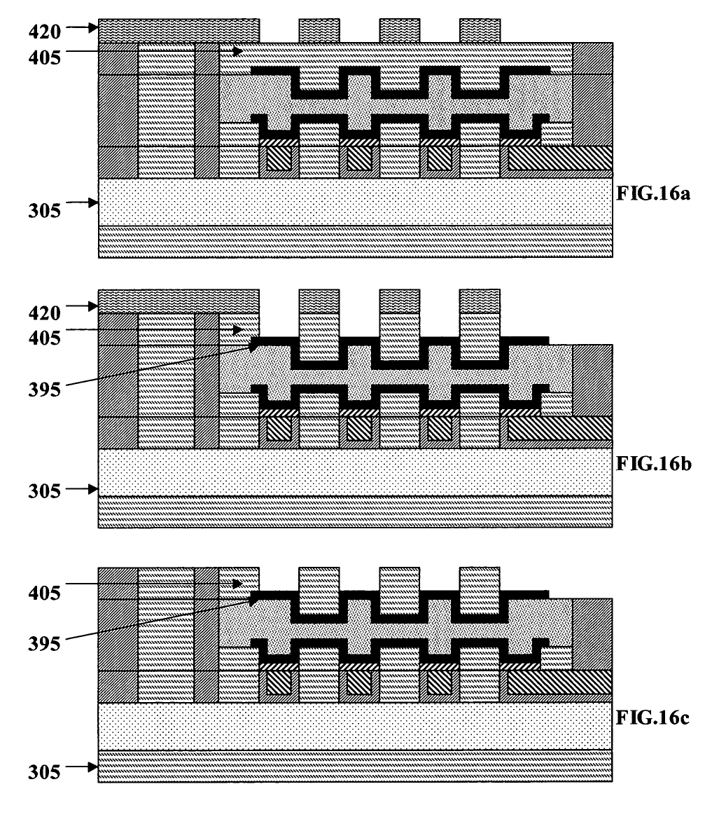

Resist mask 420 in FIG. 16a is used to etch trenches through layer 405 down to layer 395 in FIG. 16b, followed by a resist strip in FIG. 16c. Dielectric RIE processes are designed to be selective to carbon-based polymer materials such as resist and porous electrode materials so that layer 395 provides a selective etch stop to the RIE of layer 405.

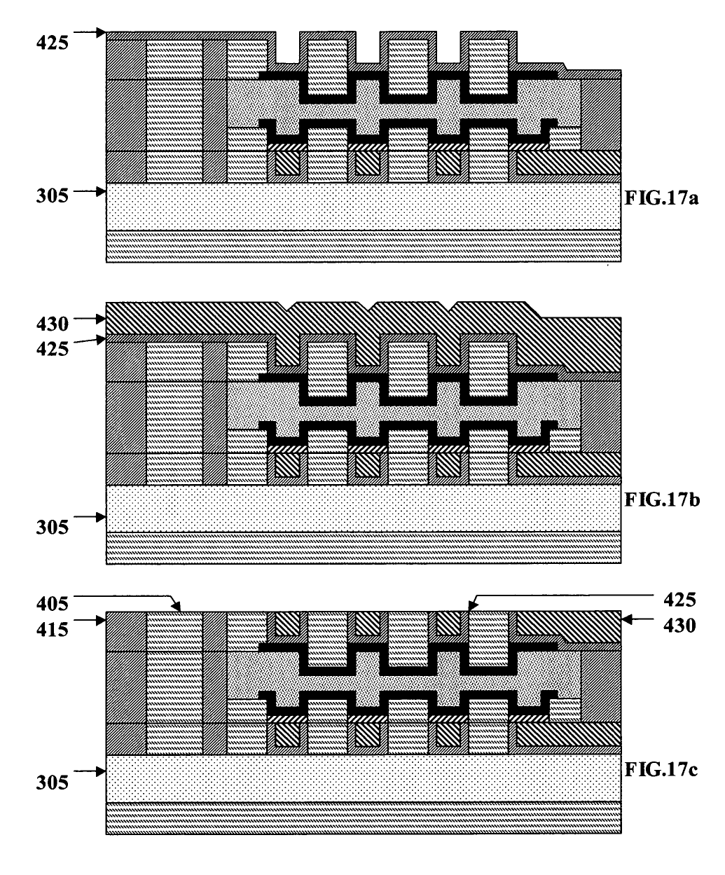

FIG. 17a shows the first step in the metalization sequence where refractory metal barrier layer 425, for example Ta or TaN, are commonly deposited using PVD in the art of microfabrication to provide a copper diffusion barrier between copper interconnect lines and surrounding low-density dielectric materials. Using damascene-type processing where trenches are etched into the dielectric a copper seed is typically plated onto the barrier layer for subsequent high-rate copper plating as in FIG. 17b, layer 430. A final CMP step, typically with an associated clean, is used to planarized the surface in FIG. 17c, isolate interconnect lines and expose portions of layers 405, 415, 425 and 430.

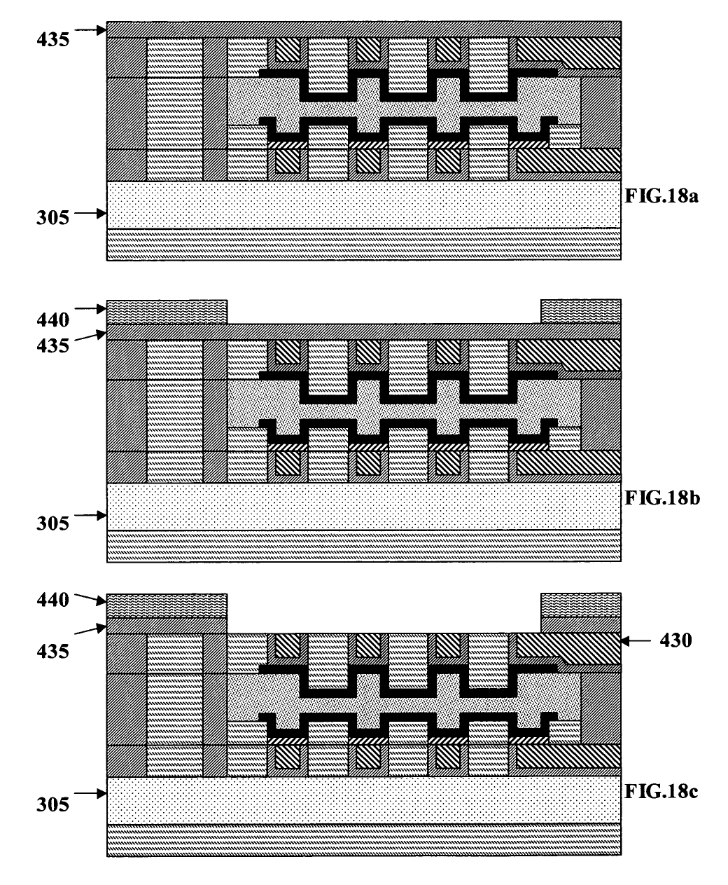

Final passivation layer 435 in FIG. 18a will eventually be used as a sealing surface with substrate 305. With a resist mask such as mask 440 in FIG. 18b, RIE processes are routinely used in the art of microfabrication to etch silicon nitride and stop at the surface exposed in FIG. 18c.

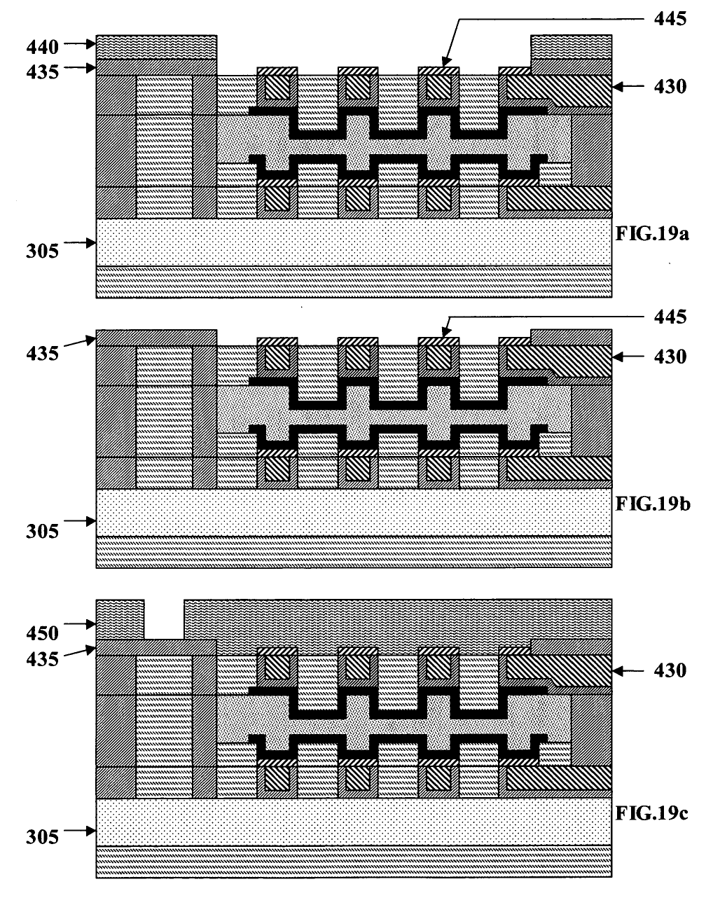

The tops of metal lines shown in FIG. 18c formed from layer 430 will eventually be exposed to fuel or oxidizer and can be protected from these reducing and oxidizing environments by capping the lines with either a dielectric or metal barrier. Either can be used since there is no requirement to make electrical contact at this surface. After stripping resist mask 440 a thin layer of silicon nitride, for example, a very good water and copper diffusion barrier, could be deposited, patterned and etched to cap the lines. Alternatively, metal cap 445 in FIG. 19a could be plated using standard techniques to protect the tops of metal lines 430 either before or after resist mask 440 is stripped in FIG. 19b.

Resist mask 450 in FIG. 19c is used to expose areas where fuel or oxidizer channels will be created. It may be noted that the proposed invention is extremely flexible regarding the number of options available for delivering fuel and oxidizer to each cell and it is not required that through holes such as 270 and 275 in FIG. 2 be fabricated since gaps such as 280 in FIG. 2 can be used to deliver fuel and oxidizer and exhaust reaction byproducts such as water and CO2.

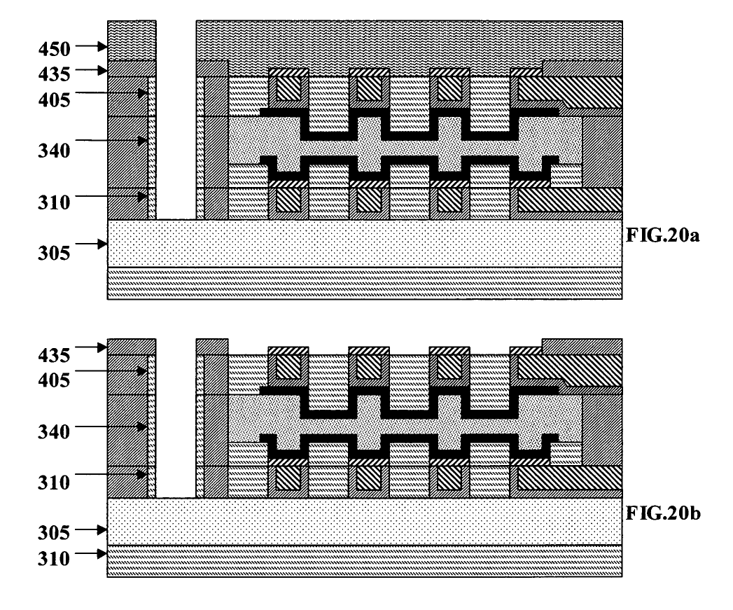

In FIG. 20a a deep RIE etch has been done through layers 435, 405, 340 and 310 stopping on substrate 305. Deep RIE etch techniques for example using O2, SF6 and CH3F include those that can be used with a resist mask. Alternatively, a metal hard mask could be used to accomplish the deep RIE step. Resist mask 450 is stripped in FIG. 20b.

Prior to etching the through holes, the substrate may be thinned by lapping and polishing in order to reduce the stacking dimensions of an array of stacked fuel cells. In this case layer 310 on the substrate backside would be removed so that another layer may need to be deposited onto the substrate backside after the thinning process. An individual fuel cell may be as thin as 0.25 mm by virtue of lap thinning, for example. A stack of 20 to 30 fuel cell elements per cm of stacking height is feasible while allowing for a thin layer of stacking adhesive between each individual cell.

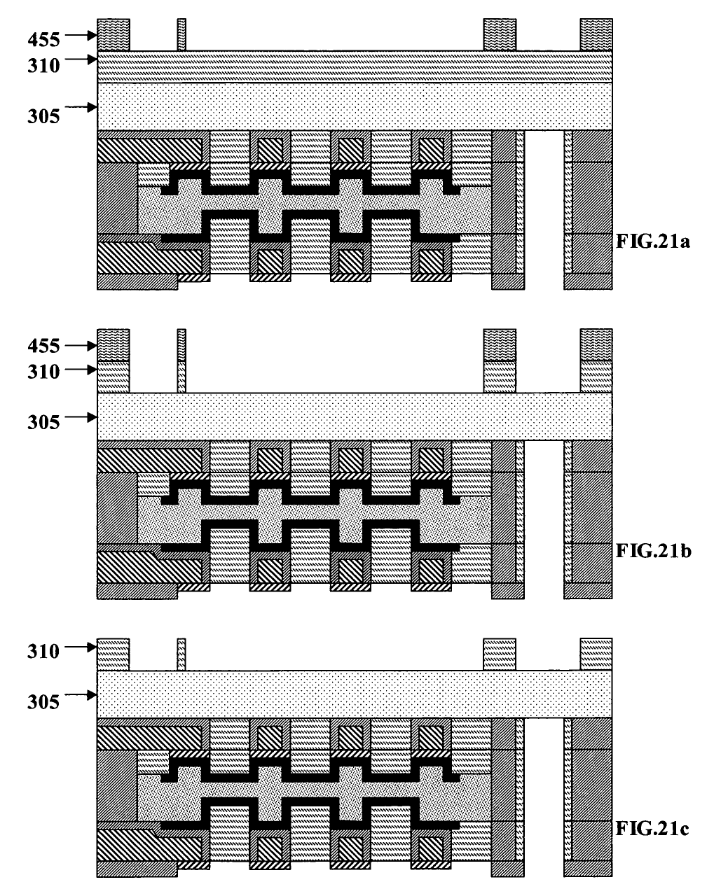

To continue the processing, the substrate is flipped over and resist mask 455 is patterned on layer 310 as shown in FIG. 21a. Layer 310 was originally deposited as a thermal oxide to coat both sides of substrate 305, and the substrate backside has remained unpatterned up to this point in the process. Layer 310 in FIG. 21b is then etched down to the substrate and resist mask 455 is stripped in FIG. 21c.

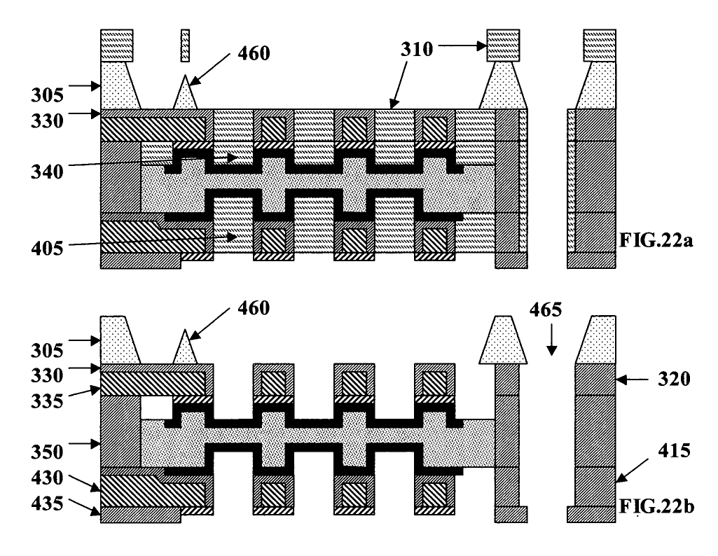

Backside layer 310 has now been patterned for use as a hardmask during substrate etch in FIG. 22a. Hardmask around the cell perimeter and around through holes allow substrate 305 to remain under these areas. If for example silicon with surface orientation in the (100) crystallographic direction is chosen as the substrate a highly anisotropic wet etch such as KOH and water can be used to etch the silicon predominately along the (100) direction. This results in trapezoidal cross sections in FIG. 22a. The base of each trapezoid makes a well-defined angle of 54.7 degrees with the surface. Dielectric layers 310, 340, and 405 remain intact during the etch since their etch rate in KOH and water is very small.

The thin hardmask region in FIG. 22a is used to make thin support beam 460 if needed to increase mechanical strength of the final membrane assembly. In this case the hardmask is completely undercut and the silicon cross section becomes triangular as the etch proceeds. Stopping the etch at the appropriate time will allow such support beams to be fabricated when silicon substrates are used, although they may also be fabricated in other substrate materials. Such support beams can be used throughout the interior of the cell and are solidly attached to the remaining substrate around the cell perimeter. In addition, the support beams are attached to the metal interconnect lines 335 via insulator layer 330. By designing the base of the support beams to be narrow, dielectric regions in layers 310 and 340 under the beam can be removed using an isotropic wet etch. As a result, no loss of active membrane area will be incurred by including support beams such as beam 460 since fuel or oxidizer will flow under the beam to the membrane after the isotropic wet etch.

Access to the membrane is created by removing layers 310, 340 and 405 in FIG. 22b. If these layers are for example silicon dioxide standard buffered hydrofluoric acid solutions can provide an isotropic etch. Layers 320, 330, 350, 415 and 435 must be resistant to this etch so that they remain intact and can for example be silicon nitride.

Metal lines from layers 335 and 430 are routed to the cell edge for external connection at the left side of FIG. 22b. Interior interconnect lines may be arranged in a comb pattern or connected in any way suitable for the given fuel cell design so that only a single line is needed to carry current from the entire electrode to the cell edge. Using metal interconnect lines provide efficient current collection from the porous electrodes, increase the membrane assembly mechanical strength, and conduct heat away from the membrane.

Current damascene technology used in the art of microfabrication can interconnect ten or more levels of copper conductors embedded in silicon dioxide. Inserting a multi-level interconnect instead of the single-layer interconnects shown in FIG. 22b would increase the mechanical strength of the membrane assembly and would greatly increase heat conduction away from the membrane. After the silicon dioxide is removed, the copper conductors would form an interconnected network while still allowing fuel and oxidizer access to the membrane. Using multi-level interconnects would therefore not decrease active area but would significantly increase heat conduction and mechanical strength.

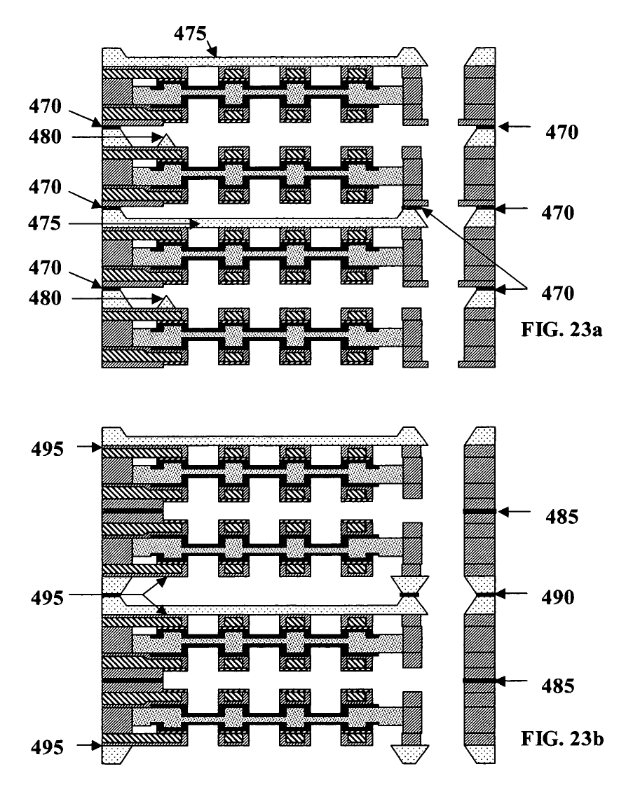

The interior of through hole 465 in FIG. 22b is coated with silicon nitride and silicon for the example of a silicon substrate. When cells are singulated, stacked and sealed in FIG. 23 the through holes allow fuel or oxidizer to enter the space between cells. When the substrate is patterned to remain around the hole, the fuel or oxidizer is passed to the next space between cells. As discussed herein, the use of through holes is not required for fuel cell operation since the fuel and oxidizer can access the membrane through cell edges. However, including through holes within the cells allows an internal manifold to be created rather than having to connect an external manifold to feed fuel and oxidizer through the cell edges.

Seals 470 in FIG. 23a can be made using epoxy, adhesive, brazing, solder, or any number of sealing techniques known in sealing art. Support beams 475 in FIG. 23a are shown running across two cells to further demonstrate how they are attached to the metal interconnect lines and the cell perimeter in a fashion that allows fuel or oxidizer to flow under the beam to the membrane. Triangular beam cross-section 480 resulting when silicon is used as the substrate is also shown in FIG. 23a.

Cells can also flipped and stacked as shown in FIG. 23b. In this case, the cells are sealed using layer 485 between two passivation layers (layer 435 of FIG. 22b) and layer 490 between two substrate layers (layer 305 of FIG. 22b).

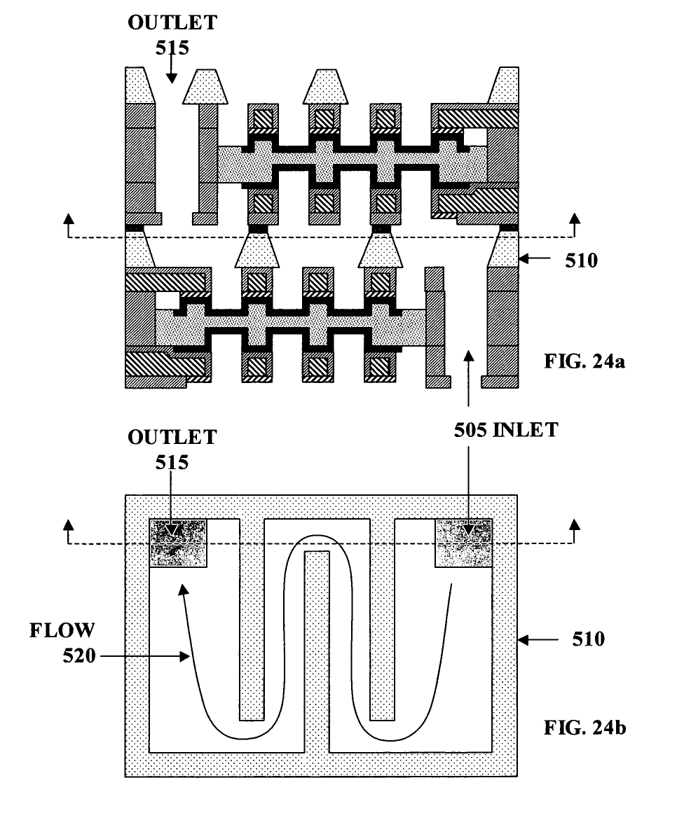

A preferred embodiment of the present invention is shown in cross-section in FIG. 24a and uses the same fabrication methods to form gas or fuel flow channels from the substrate that precisely direct flow as desired across the membrane. Fuel or oxidizer is fed in through inlet 505. Portions of substrate layer 510 are left intact in the cell interior to create flow channels so that the fuel or oxidizer flow is directed as desired across the membrane. The flow channel walls formed by the substrate can cover more than one metal line if for example the metal line width is much smaller than the width of the remaining substrate. As schematically shown in the top view of FIG. 24b, the flow is guided along channels and exits through outlet 515. The flow direction is shown by line 520 in FIG. 24b.

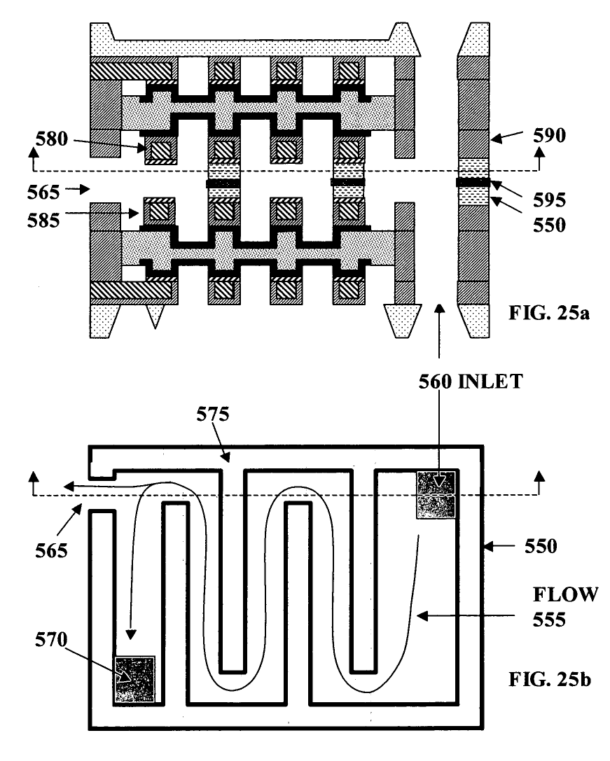

The cross-section shown in FIG. 25a is for the case where the cell is flipped before stacking and sealing. Passivation layer 550 in this case has been patterned so that portions of the layer remain in the interior of the cell so that they guide the flow in a serpentine, for example, across the membrane as shown in FIG. 25b. Fuel or oxidizer flow, depicted by arrow 555, enters the cell through inlet 560 and flows out the cell edge through gap 565. Alternatively, the flow could exit the cell vertically through hole 570 in FIG. 25b. In this case gap 565 would not be included in the structure. Shaded region 575 shows the underlying metal interconnect patterned for example in a comb structure. If passivation layer 550 is an insulator, metal interconnects 580 and 585 are isolated and can be routed to the edge of the cell for connection to other cells or external circuitry. If passivation layer 550 is conductive, the two interconnects are shorted together so that external connection can be made anywhere around the cell perimeter. If it is desirable to short the two interconnects dielectric layer 590 in FIG. 25a can be replaced with metal portions of current collector 580 so that portions of metal layer 580 remain around the cell perimeter. In this case passivation layer 550 is not included in the structure and a conductive seal 595 in FIG. 25a is used to seal the metal areas together where needed to channel flow as desired. Furthermore, if a conductive substrate is used and stacking is done in the configuration shown in both FIG. 25a and FIG. 23b, and if metal barrier layer 495 in FIG. 23b is designed to be conductive, then the substrate will be shorted to the metal current collector. After stacking and sealing the substrates together with a conductive seal, electrical connection to the substrate is available around the entire perimeter of the cell.

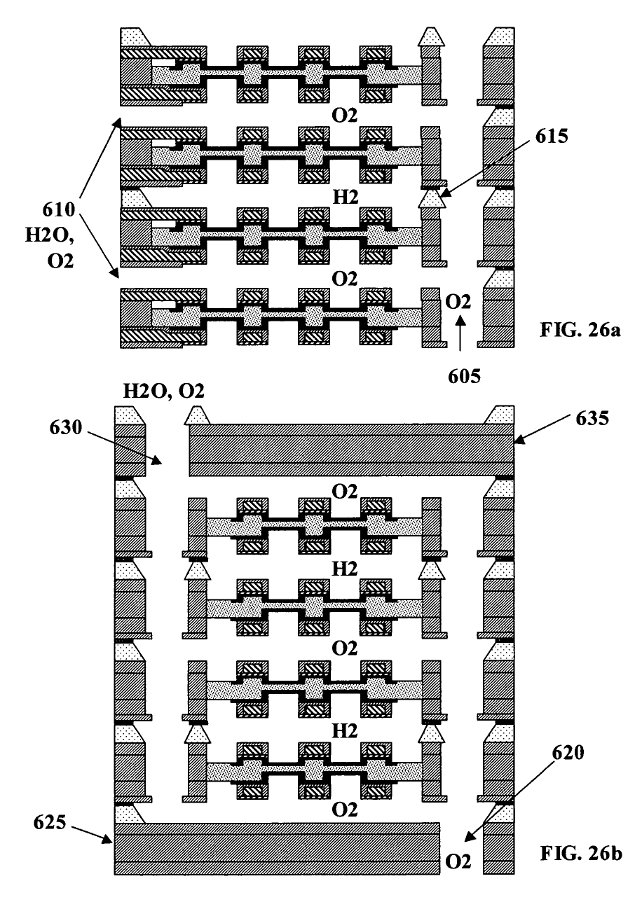

FIG. 26 shows two embodiments for delivering and exhausting fuel or oxidizer. FIG. 26a shows for example O2 flowing in through hole 605 and byproduct water and O2 flowing out through gaps 610. The seal made by the inclusion of substrate portion 615 prevents O2 from entering the anode side of the cell. In this case, gaps 610 can if needed be sealed with an external manifold. FIG. 26b shows another method for fuel or oxidizer delivery and exhaust where the flow is accomplished using internal manifolds, and also shows how the fuel cell is capped. Oxidizer flows in through hole 620 that is cut into cap 625 and out through hole 630 cut through cap 635. As previously discussed herein caps 625 and 635 can be fabricated on the monolithic substrate by leaving these cells unpatterned except where through holes are needed. In addition, caps can contain vertical interconnects to transfer current from the fuel cell to balance of plant.

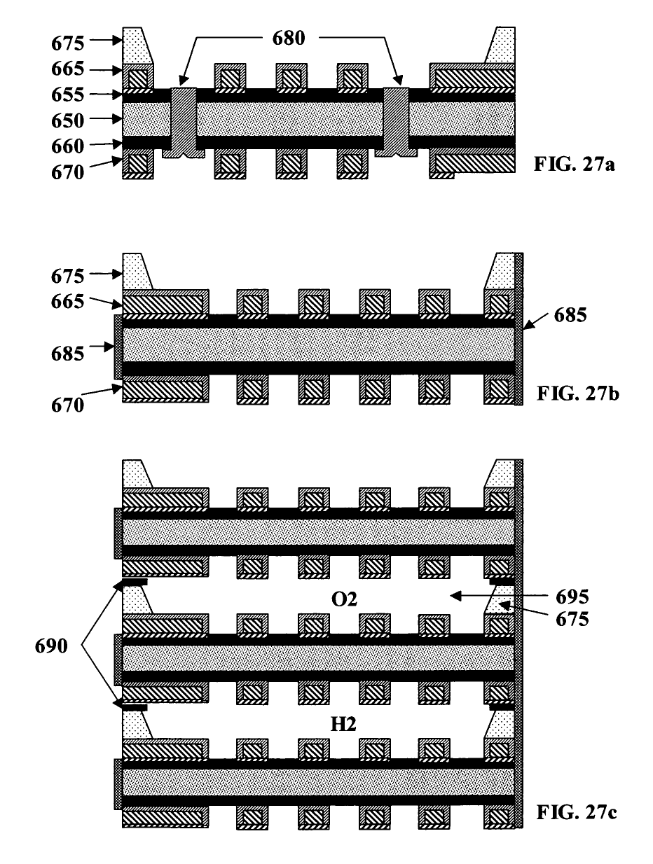

It may be noted that the fabrication process described in FIG. 3 through FIG. 23 includes many features that are not required for fuel cell operation but have been included to exemplify how microfabrication methods can be used to maximize fuel cell efficiency and minimize cell size. Many of these features can be removed to simplify the fabrication process. For example, using a planar membrane 650 in FIG. 27a instead of fabricating trenches in the membrane allows the use of planar porous electrodes 655 and 660 and greatly reduces the number of fabrication steps. In addition, metal layer 665 is fabricated by embedding it into only a single type of dielectric, as is metal layer 670, which significantly reduces the number of deposition, patterning, and polishing steps required to build the structure. Portions of metal layers 665 and 670 remain attached to substrate 675 around the cell perimeter as the dielectric is removed from between metal lines. Dielectric plugs 680 for example silicon nitride electrically isolate the membrane and porous electrodes from the cell perimeter, and can be formed by etching trenches through the membrane and porous electrodes and around the membrane active area followed for example by dielectric deposition, resist mask and etch. Trenches 680 must also run on both sides of the metal interconnect where it is routed to the cell edge in order to provide the necessary isolation.

It may be noted that plugs 680 in FIG. 27a are not required if an alternate method of sealing the edges of membrane 650 and porous electrodes 655 and 660 is used. Sealing methods such as epoxy or adhesive, for example, can be used after cell stacking to form seal 685 in FIG. 27b. The seal must allow access to the metal current collectors 665 and 670. In addition, since no through holes are present, seal 685 must allow for fuel and oxidizer delivery and exhaust through the edge of the cell. The greatly simplified embodiment of the fuel cell structure presented herein and shown in FIG. 27b can be fabricated using only three resist masks applied to a single monolithic substrate. One resist mask each is needed to form metal layers 665 and 670, and one resist mask is needed to pattern substrate 675.

If a conductive seal 690 is used in FIG. 27c the two cathode metal current collector lines common to oxidizer channel 695 are shorted together by substrate 675 if a conductive substrate is chosen. The current collector lines common to the fuel channel will also be shorted in this case. As a result, ample room for electrical connection is available around the cell perimeter.

As an alternative to making electrical connections at each cell perimeter, electrical interconnection between stacked cells can be accomplished using vertical interconnects fabricated on the monolithic substrate using only slight modifications to the process flow described in FIG. 3a through FIG. 23b. Cells within a stack can be connected in series or parallel configuration or a combination of both to match load power requirements, and only a single pair of electrical connections are required to draw power from the stacked fuel cell.

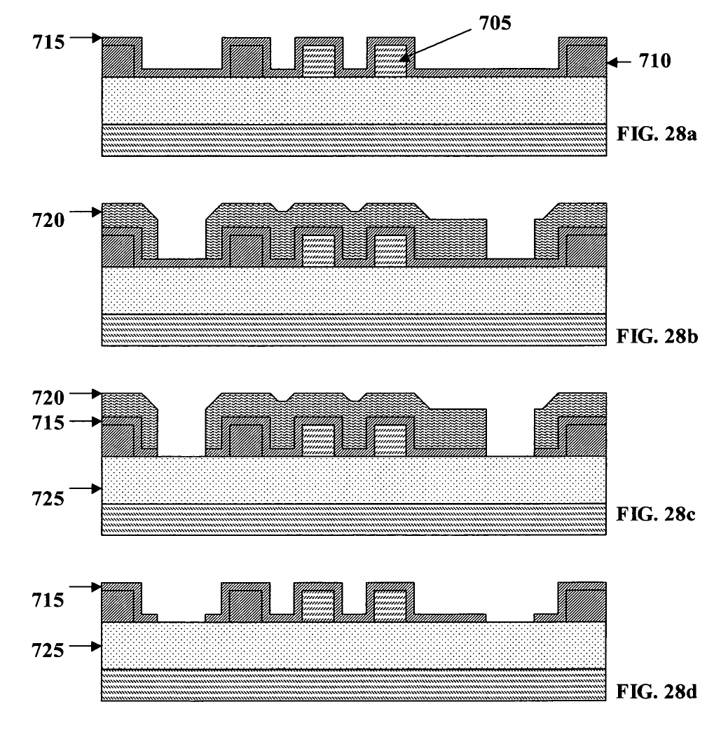

Choice of the specific vertical interconnect fabrication method depends on substrate material, stacking arrangement and other specific fuel cell requirements. One method is shown in FIG. 28a through FIG. 34c utilizing a conductive silicon substrate although those skilled in the art of microfabrication will recognize multiple ways of implementing vertical interconnect for a given set of specific materials and fuel cell requirements.

FIG. 28a shows a unit cell cross-section at the point in the process where insulator materials 705 and 710 are patterned with trenches for the first interconnect level and conformal layer 715 has been deposited. Layers 710 and 715 are for example silicon nitride and layer 705 is for example silicon dioxide. This process point is equivalent to that shown in FIG. 5a. Resist mask 720 is applied in FIG. 28b and layer 715 is etched down to substrate 725 in FIG. 28c. Resist mask 720 is stripped in FIG. 28d. Regions where substrate 725 are exposed will become part of the vertical interconnect.

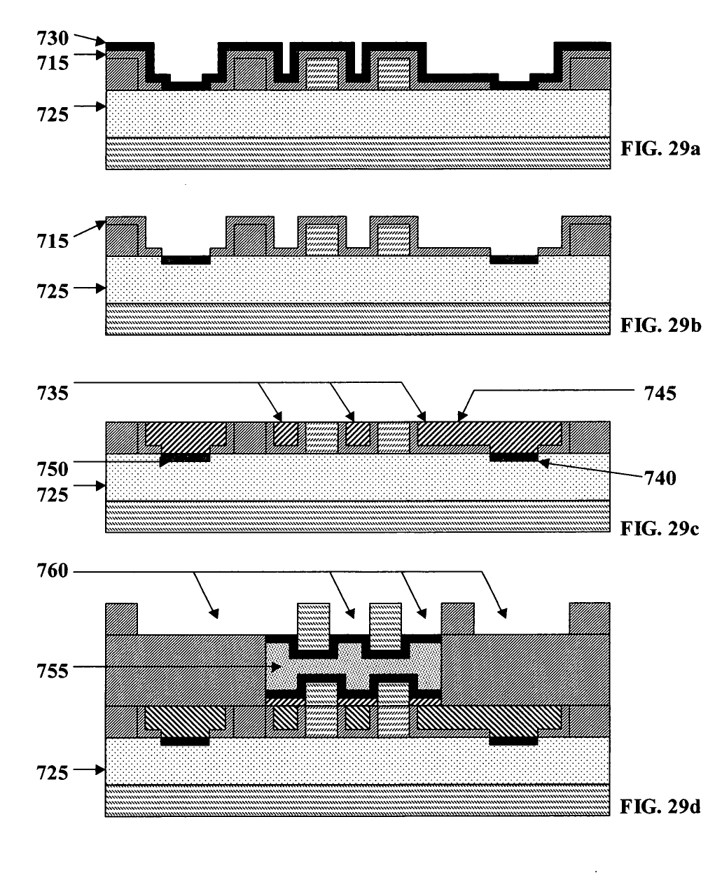

If substrate 725 is for example silicon the exposed substrate regions may need to be processed so that an ohmic contact is made between silicon and metal interconnect. Standard silicidation techniques well known in the art include for example depositing a Ti, Ni or Co layer 730 in FIG. 29a followed by annealing at temperatures above the point where the metal forms a silicide. The silicide only forms where metal makes contact with substrate 725 and the metal deposited onto insulating layer 715 may be removed using a wet etch. This leaves a metal silicide on exposed regions of substrate 725 in FIG. 29b to allow ohmic contact between silicon and the first interconnect layer. At this point if needed depending on the material to be used for the first metal interconnect, a W layer (not shown), for example, could be selectively deposited so that it only forms on the silicide and not on the surrounding insulators.

Metalization is now carried out as previously described in FIG. 5b through FIG. 5c to form the structure shown in FIG. 29c where first interconnect layer 735 is patterned for the purpose of current collection in the interior of the cell. The interior interconnect pattern is connected to conductive substrate 725 in region 740 by metal line 745 while region 750 is isolated from interconnect 735.

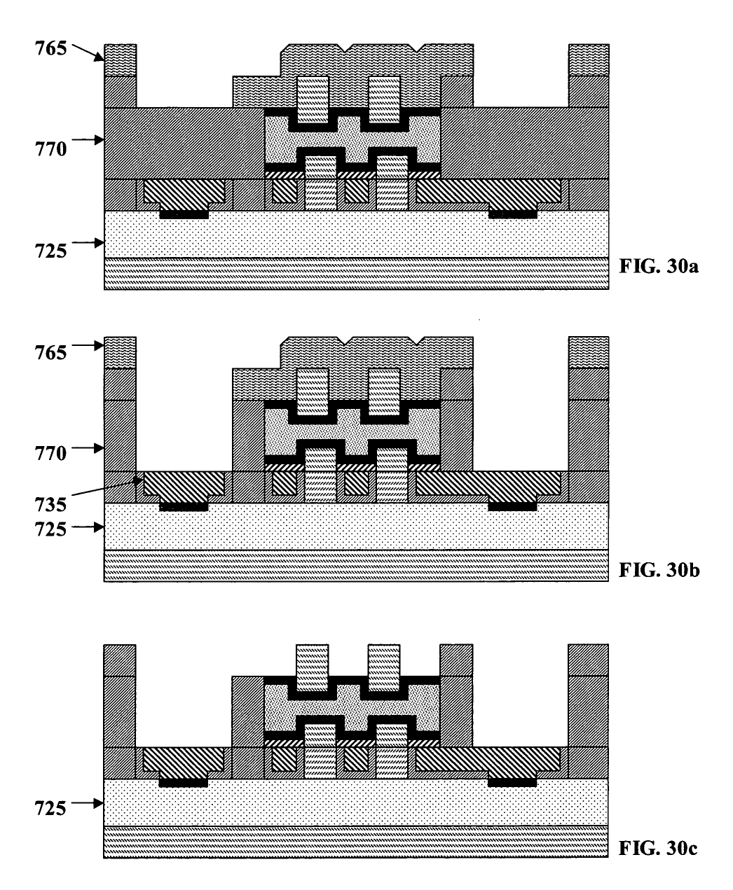

Processing continues as previously described in FIG. 5d through FIG. 16c to form membrane electrode assembly 755 and trenches 760 for metal interconnect 2 as shown in FIG. 29d. Resist mask 765 is applied FIG. 30a and layer 770 is etched down to interconnect layer 735 in FIG. 30b only in two regions for each cell where the vertical interconnect will be formed. Resist mask 765 is stripped in FIG. 30c.

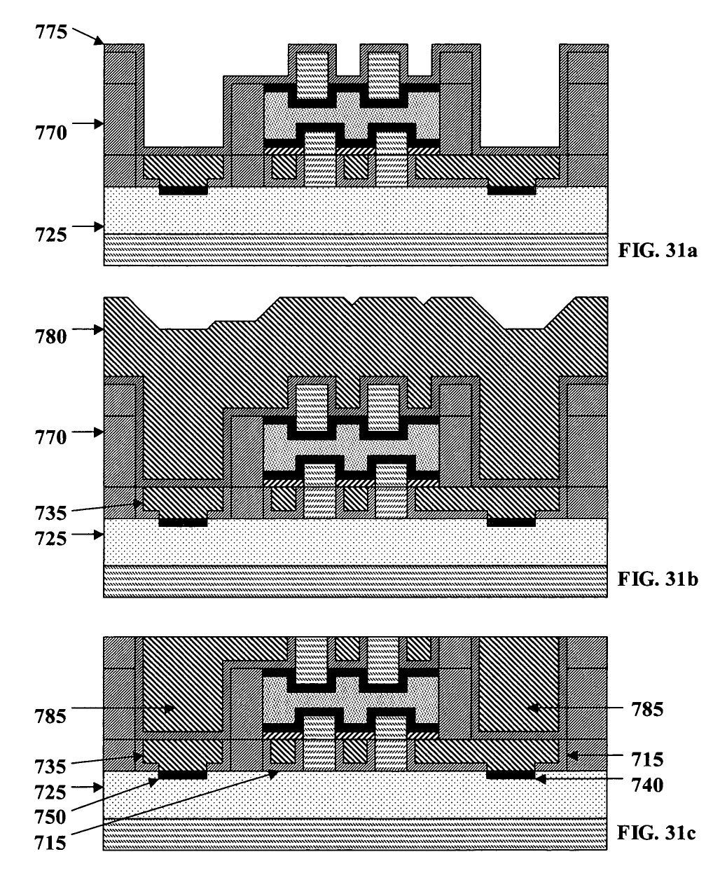

Barrier metal 775 is deposited in FIG. 31a followed by plating of layer 780 in FIG. 31b and CMP for planarization in FIG. 31c. This is the same process point as previously described in FIG. 17c. The difference between FIG. 17c and FIG. 31c is that a vertical interconnect has been formed in FIG. 31c by inserting metal plugs 785 at the membrane level to connect to upper and lower metal levels. Also, contacts between metal layer 735 have been made to substrate 725 in regions 740 and 750. Metal interconnect 735 is now isolated from the substrate everywhere else in the cell by insulator 715.

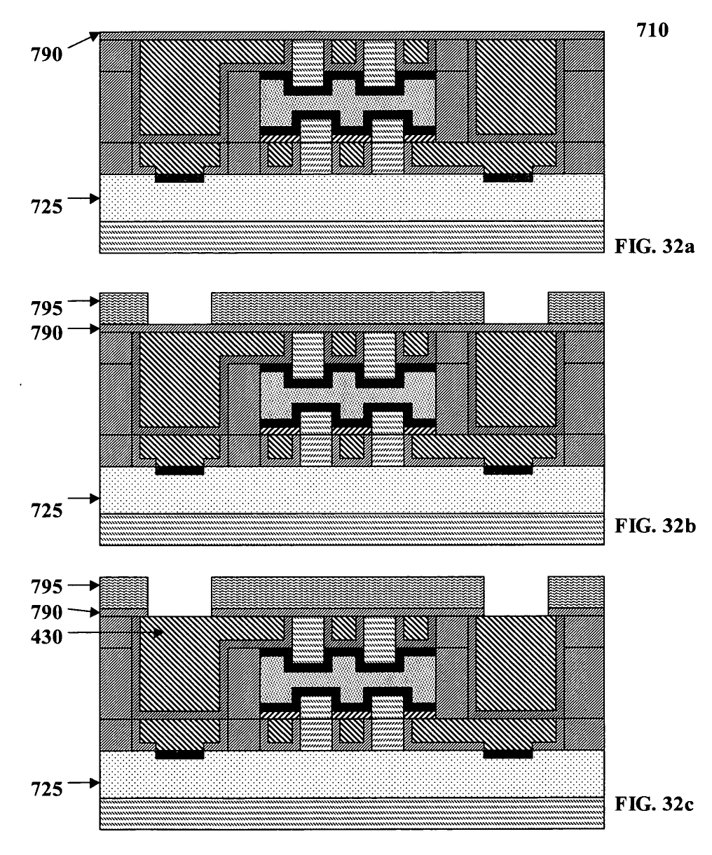

Vertical interconnect processing continues in FIG. 32a where for example silicon nitride passivation layer 790 is deposited. Resist mask 795 is applied in FIG. 32b and layer 790 is etched in FIG. 32c down to metal interconnect layer 430.

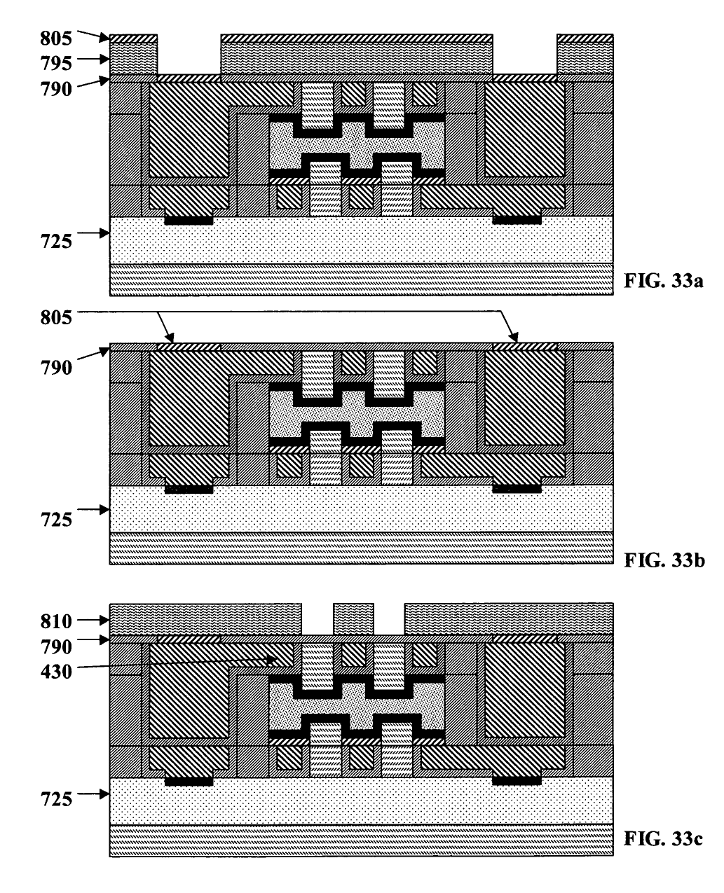

Metallic layer 805 is deposited in non-conformal fashion using for example PVD over resist mask 795 in FIG. 33a. The layer 805 thickness is designed to be about the same as layer 790 to preserve planarity. When resist mask 795 is stripped in FIG. 33b, the portions of layer 805 deposited on the resist mask are lifted off to leave layer 805 only in the vertical interconnect regions.

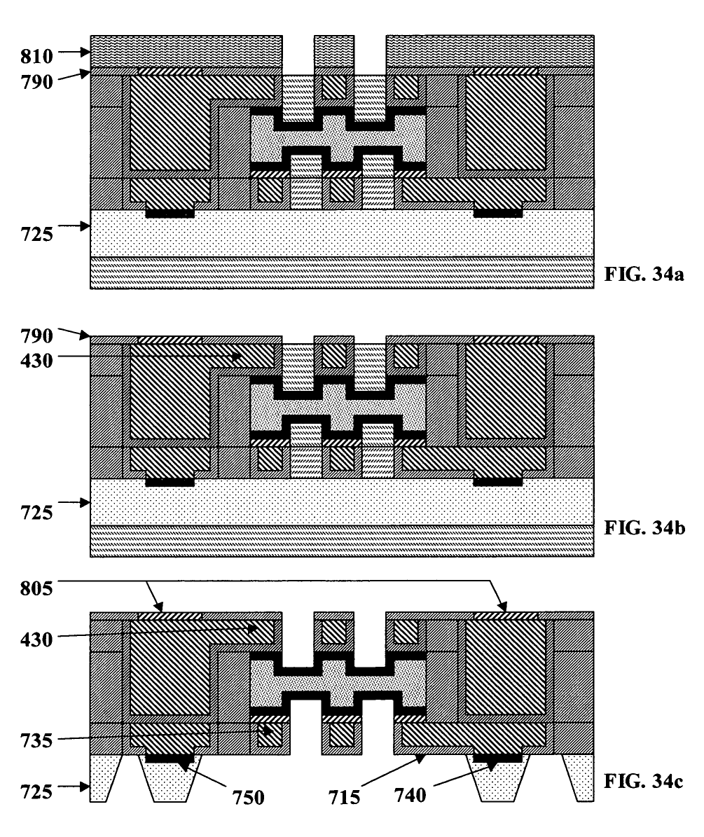

Resist mask 810 is applied in FIG. 33c to expose layer 790 only in regions between the interior interconnect lines of interconnect layer 430. Layer 790 is etched in FIG. 34a and resist mask 810 is stripped in FIG. 34b. Layer 790 now forms a cap over the metal interconnect lines in interconnect 430 to protect them from fuel or oxidizer.

Processing from this point continues as previously described in FIG. 19c through FIG. 22b to form fuel and oxidizer flow channels, etch the substrate and remove the insulator layers from between the internal interconnect lines. The final structure with vertical interconnect is shown in FIG. 34c. During pattern and etch of substrate 725, regions beneath 740 and 750 were left intact to allow the vertical interconnect to continue into the adjacent cell after stacking and sealing. Substrate regions 740 and 750 are isolated from the substrate around the cell perimeter as a result of the substrate etch.

The structure and process flow of the present embodiment allow either the top or bottom interconnect layer to be connected to the vertical interconnect as desired. Upper interconnect layer 430 in FIG. 34c is connected by the vertical interconnect to substrate region 750 and, since the substrate for this case has been chosen to be conductive, current from upper interconnect 430 is routed to the cell below through region 750. The upper interconnect is also connected through layer 805 for passage to the cell above. Similarly, lower interconnect layer 735 is connected to the vertical interconnect of the cell below through substrate region 740 and the vertical interconnect of the cell above through layer 805. The vertical interconnects shown in FIG. 34c thus form an electrical bus that runs through the entire stack for connection to other cells in the stack as necessary to meet voltage and current requirements.

Using an insulator for layer 715 in FIG. 34c allows layer 715 to be connected to substrate 725 while still providing insulation between the substrate and metal interconnect 735. In addition, since layer 715 is in direct contact with the substrate, except where layer 715 was removed by etching in the vertical interconnect regions, silicon support beams such as those shown by beams 475 and 480 in FIG. 23a may be formed if needed to increase the mechanical strength of the membrane assembly.

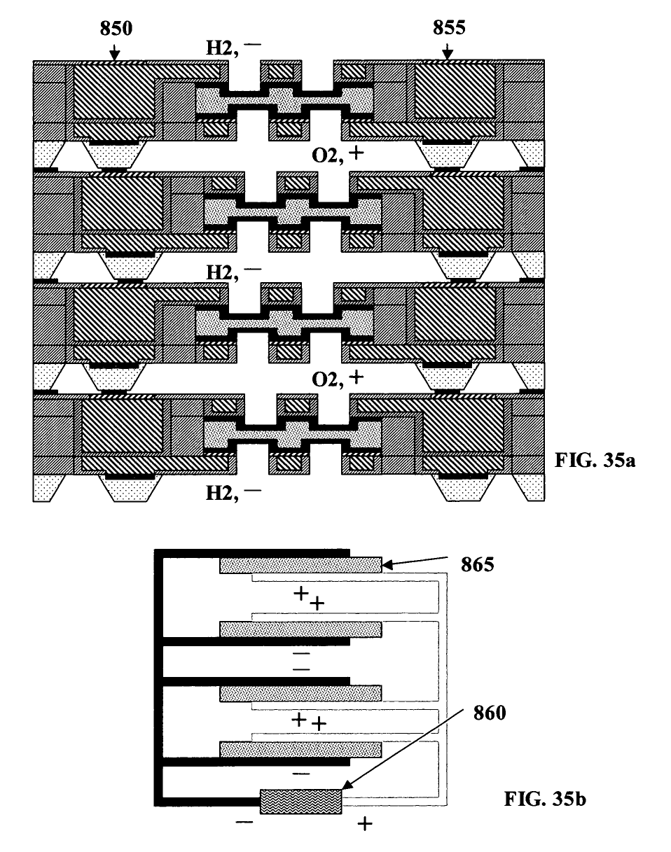

Cells can be connected in series or parallel, or a combination of both, using vertical interconnect. FIG. 35a shows a method for parallel connection where vertical interconnect 850 is connected to all negative-polarity anodes fed for example by H2 and interconnect 855 is tied to all positive-polarity cathodes in the stack fed for example by O2. The schematic diagram in FIG. 35b shows load 860 connected to four membrane assemblies 865 that correspond to the cells in FIG. 35a. Parallel connection of N cells increases current output applied by a factor of N.

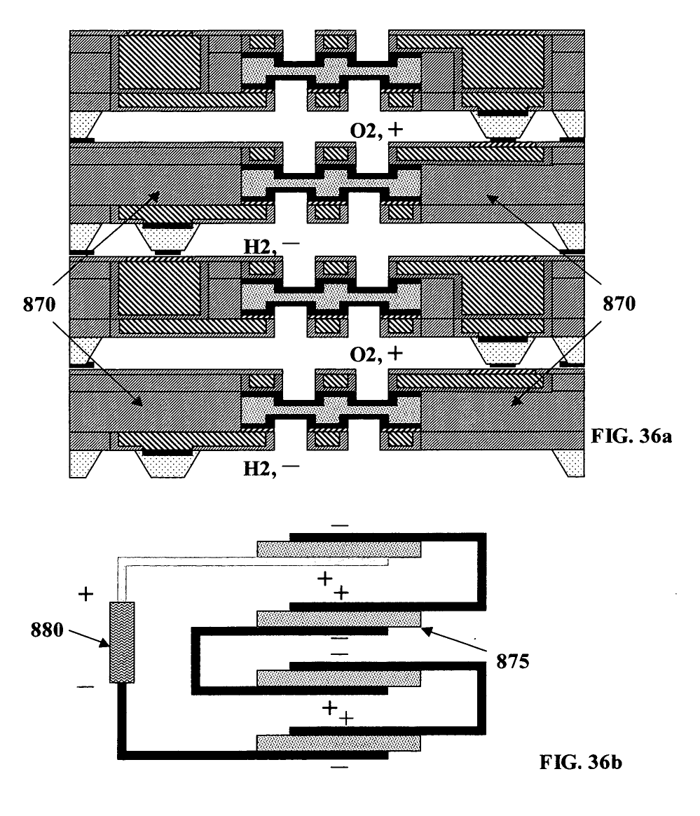

FIG. 36a shows how vertical interconnect can be used to connect cells in series. In this case the positive side of each cell is connected to the negative side of one adjacent cell. Likewise negative sides are connected to the positive side of one adjacent cell. To accomplish this vertical interconnect is not used in regions 870 of FIG. 36a. The four membrane assemblies 875 in FIG. 36b correspond to the cells in FIG. 36a, and schematically show the connection to load 880. For a stack of N cells connected in series, the output voltage is increased by a factor of N.

As previously discussed herein incorporating vertical interconnect does not preclude using silicon support beams for enhanced mechanical strength. In addition, formation of the vertical interconnect as described is compatible with formation of integral fuel and oxidizer manifolds described previously in the detailed process flow of FIG. 3a through FIG. 22b. As a result, vertical interconnect, silicon support beams, and internal fuel and oxidizer manifolds may all be used within the preferred embodiment of the present invention to form a complete fuel cell with no need for attachment of external electrical connections between individual cells or external manifolds for delivery and exhaust of fuel and oxidizer. Therefore, only two electrical connections and tubulation for fuel and oxidizer inlets and exhausts are required to interface with balance of plant.

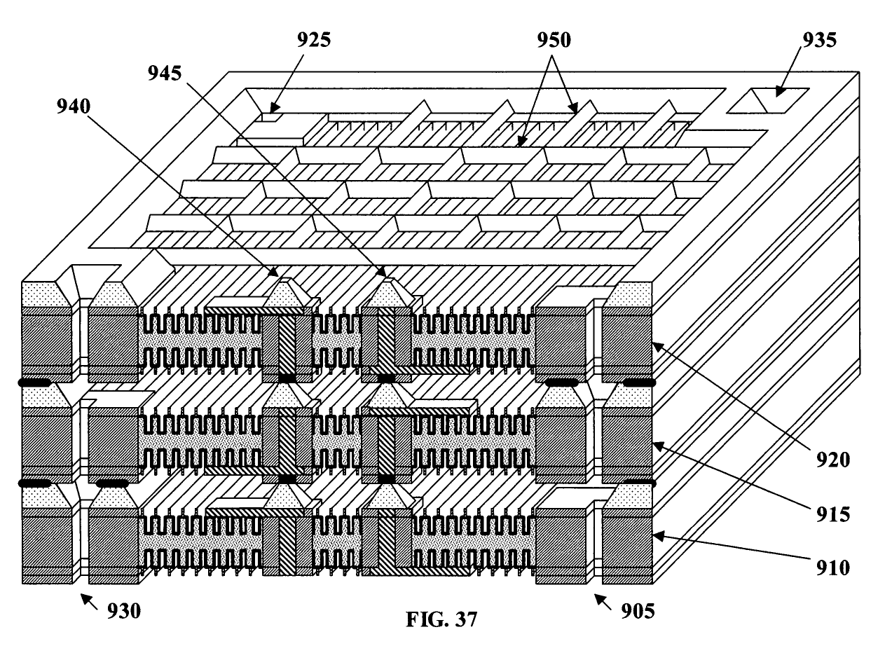

The preferred embodiment of the present invention is shown in FIG. 37. Oxidizer enters channel 905 and is distributed to the space between cells 910 and 915, and to the top of cell 920. Oxidizer exhaust leaves the stack through hole 925. Fuel is fed into channel 930 and is distributed between cells 915 and 920. The fuel exhaust leaves the stack through hole 935. The stack is connected in parallel using vertical interconnects 940 for the cathode and 945 for the anode. Beams 950 provide mechanical support.

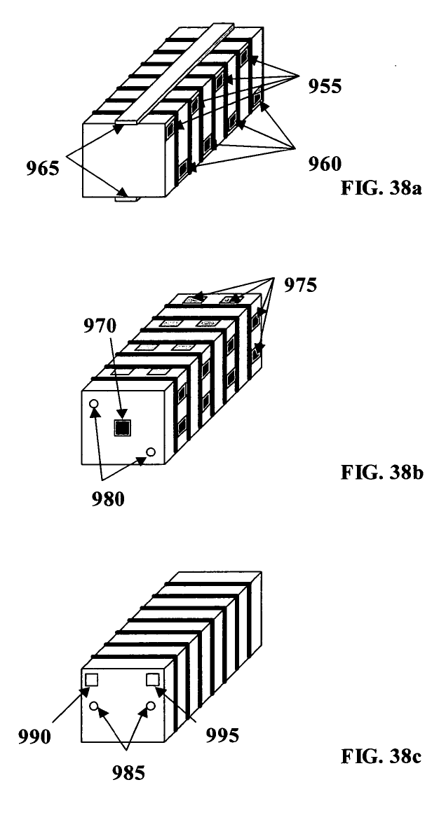

FIG. 38 includes three examples demonstrating the flexibility of the structure with regards to the options available for electrical connection and fuel and oxidizer inlets and exhausts. FIG. 38a shows a stack with oxidizer inlets 955 entering from the side of the stack through an external manifold (not shown). Oxidizer exhaust exits through the other side of the stack (not shown). In similar fashion, fuel enters the stack through inlets 960 and is exhausted through the other side of the stack. Cathode and anode connections are made through the edge of the cell using an external bus 965.

FIG. 38b shows a stack with fuel entering through channel 970 and exiting through the back (not shown). Oxidizer flows in through multiple edge gaps 975. External manifolds may not be needed if ambient air is used as the oxidizer. Electrical connection is made using vertical interconnects connected at points 980.

FIG. 38c shows a stack requiring only six connections to balance of plant, two electrical points 985, fuel inlet 990 and exhaust (not shown), and oxidizer inlet 995 and exhaust (not shown).

Current state of the art in PEMFC technology indicates an average power available per square cm of cell surface to be about 0.5 watts per square cm of active membrane. Typical output values of 1 amp at 500 mV are achievable. Thus a stack of 30 thinned substrate fuel cell elements as described in this disclosure where each element is of a size to yield about a 1 square cm of reaction area can provide 15 watts of power running efficiently on hydrogen and air.

While specific embodiments of the described invention have been disclosed along with a preferred method of manufacture the invention may be fabricated with other materials and processes that are known in the microfabrication art and the disclosed materials and processes are not intended to be limiting. Process and materials modification will become apparent to those skilled in the art.

1. We claim a fuel cell fabricated sequentially on a single monolithic substrate to form all required operating components including fuel supply and exhaust channels, oxidizer supply and exhaust channels, ion exchange membrane, electrode catalyst, positive and negative electrodes, electrical current extractor lines, and electrical interconnect between cells.

2. We claim a fuel cell fabricated on a single monolithic substrate wherein the ion exchange process takes place predominantly in a direction perpendicular to the surface of the substrate.

3. We claim an electrolyzer fabricated sequentially on a single monolithic substrate consisting of positive and negative electrodes, electrical current supply lines, cell interconnect, electrode catalyst, ion exchange membrane, and integral hydrogen and oxygen collection channels all disposed on a single monolithic substrate.

4. The fuel cell of claim 1 wherein a crystalline material and crystallographic etch are used to simultaneously form substrate regions that provide flow channels and edge seal, and also simultaneously form beams to provide mechanical support of the membrane assembly without decreasing fuel cell active area.

5. The fuel cell of claim 1 wherein vertical interconnect provides for stacking of individual fuel cells whereby such vertical interconnects are in registration thus allowing the passage of electrical current through multiply stacked fuel cells or arrays of fuel cells.

6. The fuel cell of claim 1 wherein the substrate is patterned and etched to create flow channels and edge seals.

7. The fuel cell of claim 1 wherein plated metal is used to simultaneously form an edge seal and provide flow channels.

8. The fuel cell of claim 1 wherein an insulator layer is patterned to simultaneously form an edge seal and provide flow channels.

9. The fuel cell of claim 1 wherein a large number of options exist related to how fuel and oxidizer are introduced into the fuel cell and how they are exhausted from the cell.

10. The fuel cell of claim 1 wherein a large number of options exist related to how electrical interconnect is made to each cell.

11. The fuel cell of claim 1 wherein the surface area of the ion exchange membrane is increased in order to facilitate ion exchange and to yield higher output power density per unit area of substrate.

12. The fuel cell of claim 1 wherein ion milling is used to increase electrode surface area prior to catalyst application in order to increase current density.

13. The fuel cell of claim 1 wherein ion milling is used to increase electrode surface area prior to membrane application in order to increase current density.

14. The fuel cell of claim 1 wherein ion milling is used to increase membrane surface area prior to application of catalyst or porous membrane containing catalyst in order to increase current density.

15. The fuel cell of claim 1 wherein the substrate is comprised of insulating, semi-insulating, semiconducting, or conductive material.

16. The fuel cell of claim 1 wherein singulated fuel cell elements are stacked and interconnected to form a higher output power module than would be available from a single fuel cell element or an array of fuel cell elements on a single substrate.

17. The fuel cell of claim 1 wherein manifold supply chambers provide for stacking of individual fuel cells whereby such manifold chambers are in registration thus allowing the passage of fuel and oxidizer through multiply stacked fuel cells or arrays of fuel cells.

18. The fuel cell of claim 1 wherein a multiplicity of fuel cells fabricated on a single substrate can be singulated then stacked by hermetically bonding one to another.

19. The fuel cell of claim 1 wherein a multiplicity of single fuel cells on a single substrate are interconnected such that electrical current extractor lines are routed to the edge of a single substrate to provide connection to external devices or electrical loads.

20. The fuel cell of claim 1 wherein a monolithic semiconductor substrate contains pre-existing active semiconductor circuits for the purpose of controlling operation of the fuel cell.

21. The fuel cell of claim 1 wherein the monolithic substrate contains active MEMS type devices for controlling mechanical functions of the fuel cell.

22. The fuel cell of claim 1 wherein the fuel cell structure may be a Proton Exchange Membrane (PEMFC) type or a Solid Oxide Type (SOFC) or Solid Polymer Type (SPFC), depending on the selection of fabrication materials.

23. The fuel cell of claim 1 wherein the fuel source is comprised of alcohols, hydrogen gas, or other fuels containing redox pairs.

24. The fuel cell of claim 1 wherein the oxidizer source is air or oxygen.

25. The fuel cell of claim 1 wherein the operating temperature range may be from 70° C. to 800° C. depending on the type of said cell and the material system used.

26. The fuel cell of claim 1 wherein the lateral dimensions of the electrical conductors are within the range of from 0.05 micron to 1 mm for the purpose of using standard semiconductor and microfabrication manufacturing techniques.

27. The fuel cell of claim 1 wherein the electrical current extractor lines and the substrate are of high thermal conductivity for the purpose of removing heat from the active region of the fuel cell.

28. The fuel cell of claim 1 wherein multi-level electrical current extractor lines are used to increase thermal conductivity for the purpose of removing heat from the active region of the fuel cell without decreasing fuel cell active area.

29. The fuel cell of claim 1 wherein multi-level electrical current extractor lines are used for the purpose of increasing mechanical strength of the fuel cell without decreasing fuel cell active area.

30. The fuel cell of claim 1 wherein structure buildup is accomplished by methods common in the semiconductor and MEMS fabrication industry including but not limited to physical vapor deposition, chemical vapor deposition, plating, spin coating, dipping, spraying and cladding.

31. The fuel cell of claim 1 whereby structure patterning is accomplished by standard semiconductor or MEMS photomasking technique followed by etch removal or additive deposition techniques.

32. The fuel cell of claim 1 wherein masking is accomplished using standard photoresist and lithography printing techniques common in the semiconductor and MEMS fabrication industry.

33. The fuel cell of claim 1 wherein subtractive removal is accomplished using either laser ablation, stamping, ultrasonic grinding, lapping or polishing, machining, or wet or dry etching.

34. The fuel cell of claim 1 wherein subtractive feature formation is accomplished by vacuum etching processes such as sputter etching, reactive ion etching, reactive ion beam etching, deep reactive ion etching.

35. The fuel cell of claim 1 wherein anode and cathode electrical conductor lines are comprised of plated copper, gold, nickel or palladium or a combination of those.

36. The fuel cell of claim 1 wherein an inert corrosion barrier is comprised of a refractory conductor such as tantalum, tantalum nitride, titanium-tungsten nitride, or rhodium.

37. The fuel cell of claim 1 wherein an inert corrosion barrier is comprised of a patterned dielectric such as silicon nitride or silicon carbide.

38. The fuel cell of claim 1 wherein a membrane material is deposited by spin coating, spraying, dipping, or chemical vapor deposition.

39. The fuel cell of claim 1 wherein the electrode material is applied to anisotropically etched features in a membrane by physical vapor deposition, chemical vapor deposition, spin coating, dipping or doctor blading, followed by heat curing.

40. The fuel cell of claim 1 wherein metallic layers are built by plating copper, nickel, gold, or a combination thereof, for example.

41. The fuel cell of claim 1 wherein an insulating barrier layer is applied to the surface of conductive elements by vacuum deposition, physical vapor deposition, chemical vapor deposition or other conventional means for the purpose of electrically insulating one element from another or eliminating corrosion between dissimilar materials.
